(19) United States
(12) Patent Application Publication
(10) Pub. No.: US 2025/0343575 A1
(43) Pub. Date: Nov. 6, 2025

(54) RECONFIGURABLE INTELLIGENT SURFACES THAT SELF HEAL AND ADAPT BY ALTERING THE TILE GEOMETRY

(71) Applicant: Dell Products L.P., Round Rock, TX (US)

(72) Inventors: Navjot Kaur Khaira, Manotick (CA); Tejinder Singh, Manotick (CA); Raja Neogi, Portland, OR (US)

(21) Appl. No.: 18/656,431

(22) Filed: May 6, 2024

(51) Int. Cl. H04B 7/04; H04B 7/06

(52) U.S. Cl. CPC H04B 7/04013; H04B 7/0617; H04B 7/06954

(57) ABSTRACT

The technology described herein is directed towards a reconfigurable intelligent surface that is controlled by an artificial intelligence/machine learning (AI/ML) model of a local tile controller. Adaptive shaping of a reconfigurable intelligent surface's geometry by the model produces a desired coverage pattern, including signal strength determined by a model-determined aperture of subarrays of unit cells, and beam direction via controlled phase shifts of the unit cells. Such on-demand reconfiguration adapts the surface for different operating conditions. Further, the model can repair (self-heal) a reconfigurable intelligent surface, by selecting a different aperture that does not include a failing subarray. Each model is locally trained based on local data, as well as federated learning data obtained from other models and aggregated at a centralized controller that learns a global model from the aggregated data. Model optimization via retraining is an ongoing process for continued model improvement.

### BACKGROUND

Reconfigurable intelligent surfaces, also referred to as metasurfaces or tiles/panels, refer to artificially designed structures or surfaces that can manipulate electromagnetic waves in a manner that is not achievable using natural materials. These surfaces can be controlled to produce desired changes in the propagation of the waves, such as reflection, refraction, absorption, and polarization. By controlling the reflection and/or refraction of electromagnetic waves, reconfigurable intelligent surfaces can create more favorable propagation environments, improving signal quality and reducing interference by steering wireless signals to desired areas, thereby enhancing the coverage in shadowed or traditionally weak signal zones.

### BRIEF DESCRIPTION OF THE DRAWINGS

The technology described herein is illustrated by way of example and not limited in the accompanying figures in which like reference numerals indicate similar elements and in which:

FIG. 1 is a block diagram representation showing an example system for integrating a trained artificial intelligence model with a tile controller of reconfigurable intelligent surfaces, in accordance with various embodiments and implementations of the subject disclosure.

FIG. 2 is a block diagram representation showing an example system facilitating federated learning with respect to trained artificial intelligence models with tile controllers of reconfigurable intelligent surfaces, in accordance with various embodiments and implementations of the subject disclosure.

FIG. 3 is a block diagram representation showing an example deployment of various reconfigurable intelligent surfaces to provide wireless coverage to locations in a usage environment, in accordance with various embodiments and implementations of the subject disclosure.

FIG. 4 is a representation of example subarrays that can be connected together to form a higher order m×n reconfigurable intelligent surface array, in accordance with various embodiments and implementations of the subject disclosure.

FIGS. 5A and 5B are example top view (FIG. 5A) and three-dimensional perspective view (FIG. 5B) representations of an example unit cell useable with a reconfigurable intelligent surface, in accordance with various embodiments and implementations of the subject disclosure.

FIGS. 6A and 6B are front and back views, respectively, of an example 3×3 array of unit cells of a module, in accordance with various embodiments and implementations of the subject disclosure.

FIG. 7 is a cross-sectional view of an example unit cell usable with a reconfigurable intelligent surface, showing a stack and arrangement of fabricated layers, in accordance with various embodiments and implementations of the subject disclosure.

FIGS. 8-10 are representations of example configurations of a reconfigurable intelligent surface with different active apertures for wireless signal reflection, in accordance with various embodiments and implementations of the subject disclosure.

FIGS. 11 and 12 comprise a flow diagram showing example operations related to deployment of a reconfigurable intelligent surface and model training operations of a tile controller model coupled to the reconfigurable intelligent surface, in accordance with various embodiments and implementations of the subject disclosure.

FIGS. 13-16 comprise a flow diagram showing example operations related to local model training and signal processing at a tile controller, in accordance with various embodiments and implementations of the subject disclosure.

FIGS. 17-19 comprise a flow diagram showing example operations related to a training a centralized federated learning model for a (e.g., cloud-based) software defined metasurface controller for federated learning used in training local models, in accordance with various embodiments and implementations of the subject disclosure.

FIG. 20 is a representation of an example reconfigurable intelligent surface with self-healing by changing from an aperture coverage pattern with a failing subarray to another aperture coverage pattern that does not use the failing subarray, in accordance with various embodiments and implementations of the subject disclosure.

FIG. 21 is a representation of an example reconfigurable intelligent surface with a relatively smaller number of cells, which provides a relatively lower gain that is less directional and covers a relatively larger area, in accordance with various embodiments and implementations of the subject disclosure.

FIG. 22 is a representation of an example reconfigurable intelligent surface with an increased number of cells (relative to FIG. 21), which provides a relatively medium reflected signal gain and a relatively narrow RF beam that provides relatively medium coverage, in accordance with various embodiments and implementations of the subject disclosure.

FIG. 23 is a representation of an example reconfigurable intelligent surface with an increased number of cells (relative to FIG. 22), showing how a phase profile spread over a large reconfigurable intelligent surface aperture provides a relatively sharp reflected RF beam that offers relatively very high signal gain, in accordance with various embodiments and implementations of the subject disclosure.

FIG. 24A is a representation of an example phase profiles of elements of reconfigurable intelligent surfaces, in accordance with various embodiments and implementations of the subject disclosure.

FIGS. 24B and 24C are representations of an example pre-configuration and post-configuration of a module (FIG. 24B) and corresponding pre-configuration and post-configuration beam reflection directions (FIG. 24C), in accordance with various embodiments and implementations of the subject disclosure.

FIG. 25A is an example directivity diagram showing the signal gain and main lobe corresponding to one reconfigurable intelligent surface module (a 3×3 array of unit cells), in accordance with various embodiments and implementations of the subject disclosure.

FIG. 25B is an example directivity diagram showing the signal gain and main lobe corresponding to one reconfigurable intelligent surface configuration (a 6×6 array), in accordance with various embodiments and implementations of the subject disclosure.

FIG. 26A is an example directivity diagram showing the signal gain and main lobe corresponding to another reconfigurable intelligent surface configuration (a 12×12 array), in accordance with various embodiments and implementations of the subject disclosure.

FIG. 26B is an example directivity diagram showing the signal gain and main lobe corresponding to yet another reconfigurable intelligent surface configuration (an 18×18 array), in accordance with various embodiments and implementations of the subject disclosure.

FIG. 27 is a flow diagram showing example operations related to applying configuration data obtained from a trained tile controller's model to a reconfigurable intelligent surface to redirect incoming electromagnetic signals based on a specified beam direction and a specified beam strength, in accordance with various embodiments and implementations of the subject disclosure.

FIG. 28 is a flow diagram showing example operations related to obtaining configuration data corresponding to phase data and an aperture coverage pattern for redirecting incoming electromagnetic signals from a reconfigurable intelligent surface, in accordance with various embodiments and implementations of the subject disclosure.

FIG. 29 is a flow diagram showing example operations related to determining a different aperture coverage pattern for a reconfigurable intelligent surface in response to determining that an existing aperture coverage pattern includes a potentially failing subarray, in accordance with various embodiments and implementations of the subject disclosure.

### DETAILED DESCRIPTION

Various embodiments and implementations of the technology described herein are generally directed towards a reconfigurable intelligent surface that is controlled by an artificial intelligence/machine learning (AI/ML) model of a local tile controller, which can intelligently adjust the coverage and signal strength of beams redirected by the reconfigurable intelligent surface. The tile controller facilitates adapting to the environment by altering the reconfigurable intelligent surface (tile) geometry to control beam direction, corresponding to individual phase shifts of unit cells (elements) of the reconfigurable intelligent surface, and beam strength, corresponding to a selected aperture coverage pattern, as appropriate for a specified beam direction and specified beam strength. The beam direction and beam strength are selected as appropriate for certain conditions and coverage areas. The surrounding spectral environment can be explored and learned by identifying a desirable coverage pattern corresponding to the specified beam direction and the specified beam strength. In addition to beam shaping and beam steering, altering the tile geometry allows for self-healing of the reconfigurable intelligent surface, such as by selecting a different aperture upon the model detecting that one or more unit cells, e.g., arranged in a subarray of unit cells, is failing.

In general, reconfigurable intelligent surfaces (RISs) improve the energy efficiency in wireless infrastructure by reconfiguring the wireless propagation environment. As described herein, adaptive shaping of a reconfigurable intelligent surface's geometry, in conjunction with decentralized learning, makes a reconfigurable intelligent surface even more operationally efficient. Based on the technology described herein described herein, reconfigurable intelligent surface elements are AI-controlled to produce a desired coverage pattern. With respect to beam direction, the AI model can determine the unit cell phases for reconfiguring the intelligent surface's unit cells. With respect to signal strength, the reconfigurable intelligent surface aperture is shaped by composing a surface geometry that can be scaled on-demand; a smaller array provides coverage over larger area but with reduced strength, while alternatively activating a larger aperture provides a stronger signal strength over a smaller area (focused narrower beams). Such on-demand reconfiguration allows the surface to be adapted to different operating conditions and fulfill diverse tasks efficiently, along with repairing itself in case of failures.

The model is locally trained (per on-site tile controller coupled to one or more reconfigurable intelligent surfaces to initialize and update a reconfigurable intelligent surface's model parameters based on current electromagnetic waves that are impinging on the reconfigurable intelligent surface. Further, the tile controllers are implemented as part of an infrastructure for federated learning based on the on-site tile controllers and a centralized metasurface controller, as described herein. Real-time optimization of the surface geometry with distributed intelligence in the centralized controller and tile controllers leads to improved beamforming, focusing, and signal transmission efficiency in communication systems.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

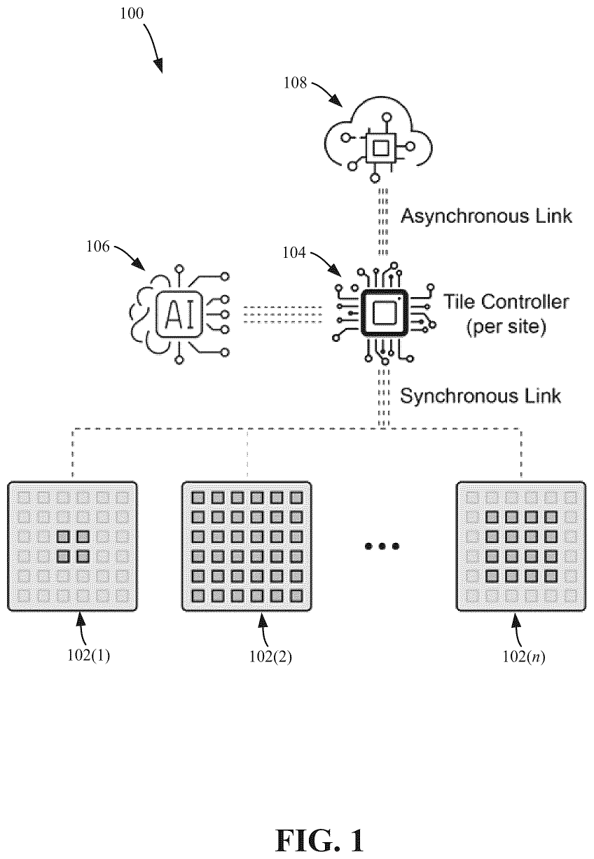

FIG. 1 shows a generalized block diagram of an example system 100 including a group of reconfigurable intelligent surfaces 102(1)-102(n), e.g., deployed at a particular site, coupled to a tile controller 104 for that site, e.g., by a synchronous link. The tile controller 104 is coupled to or incorporates an AI model 106, e.g., a local on-site compute engine, which, among other operations, determines the aperture coverage pattern for each of the reconfigurable intelligent surfaces 102(1)-102(n), by independently turning subarrays (groupings of unit cell elements) within the reconfigurable intelligent surfaces 102(1)-102(n) to ON or OFF states. The tile controller 104 guides the microcontrollers in each subarray (e.g., module) of unit cells to produce driving voltages for their integrated varactors, as well as individually control the phases of the unit cells of each subarray.

In general, in the drawing figures including FIG. 1, the darker squares within a reconfigurable intelligent surface represent which subarrays are turned to the ON state, while the lighter squares indicate the subarrays that are turned to the OFF state. For example, in FIG. 1, the reconfigurable intelligent surface 102(1) currently has a relatively small aperture determined by four turned-on subarrays (of thirty-six available subarrays in this example), the reconfigurable intelligent surface 102(2) currently has a maximum aperture determined by all thirty-six turned-on subarrays, and the reconfigurable intelligent surface 102(n) currently has a medium aperture determined by sixteen turned-on subarrays. These can be varied on demand, and while in this example the apertures are determined by the model 106 as x² subarray groups, this is not a limitation; e.g., there can be a subarray aperture of 2×3 subarrays. Moreover, although the example of FIG. 1 depicts the three reconfigurable intelligent surfaces 102(1)-102(n) with 6×6 available subarrays each, this is a non-limiting example, and there can be any practical number of available subarrays on a given reconfigurable intelligent surface, and the reconfigurable intelligent surfaces managed by the same tile controller need not be the same size as one another.

FIG. 1 also shows part of the concept of distributed learning for reconfigurable intelligent surface optimization. More particularly, federated learning as described herein enables multiple nodes in a network to collaboratively learn a shared prediction model, via a connection (e.g., via an asynchronous link) from the tile controller 104 to a centralized controller 108, e.g., a cloud-hosted AI compute global controller, while keeping the training data on (or locally coupled to) the local device 104. In the context of network optimization, such a decentralized network optimization approach is unlike other known network optimization techniques.

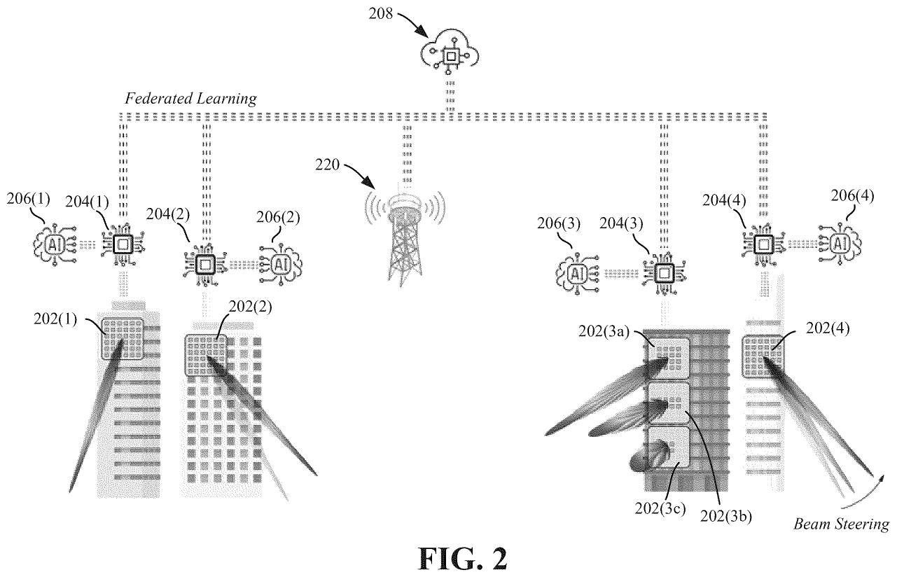

FIG. 2 shows an example of federated learning for reconfigurable intelligent surfaces 202(1)-202(4) (including reconfigurable intelligent surfaces 202(3a)-202(3c)) deployed on (or alternatively within) buildings at different sites, corresponding to different local per-site tile controllers 204(1)-204(4) with their AI models 206(1)-206(4), respectively. The reconfigurable intelligent surfaces 202(1)-202(4) reflect incoming signals from a base station 220. As can be seen in FIG. 2, customizable signal gain and flexible coverage area are determined by the tile controllers 204(1)-204(4) and respective AI models 206(1)-206(4).

In the example of FIG. 2, a single tile controller such as 204(3) equipped with the AI model 206(3) can manage the reconfigurable intelligent surfaces (panels) 202(3a), 202(3b) and 202(3c) on and/or in a building, adjusting the reflected beam dynamics (direction and strength) from each panel. This can be dynamic for any reconfigurable intelligent surface, such as shown by the beam steering capability of the reconfigurable intelligent surface 202(4). Note that in this example, the highest reconfigurable intelligent surface 202(3a) deployed on the building is configured for a high power (corresponding to a narrower width) beam, the middle reconfigurable intelligent surface 202(3b) is configured for a medium power (corresponding to a medium width) beam, and the lowest reconfigurable intelligent surface 202(3c) is configured for a low power (corresponding to a wider width) beam. As such, the reconfigurable intelligent surface 202(3a) is currently configured to cover more a distant coverage area, the reconfigurable intelligent surface 202(3c) is currently configured to broadly cover a nearby coverage area, and the reconfigurable intelligent surface 202(3b) is currently configured to cover the coverage area in-between the others.

In FIG. 2, the base station 220 and the local per-site tile controllers 204(1)-204(4) are coupled to the centralized controller 208 for collaborative, yet independent learning. In general, federated learning fosters a collaborative learning environment where the different reconfigurable intelligent surface units (e.g., 202(1)-202(4) in this example) contribute to a shared model while maintaining independent control over their data, as described herein. This balance of collaboration and independence is unlike other network management approaches.

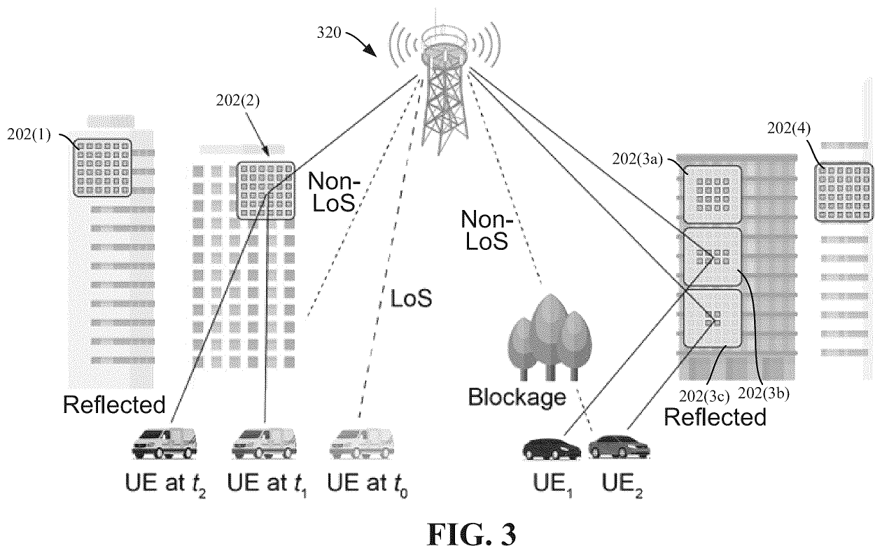

When utilized outdoors as generally represented in the example of FIG. 3, reconfigurable intelligent surfaces can create specific beam patterns that improve connection with a base station 320. As can be seen, the signal on non-line-of-sight (non-LoS) paths is enhanced by an appropriately deployed reconfigurable intelligent surface, e.g., to avoid blockage/buildings. In this way, appropriately deployed reconfigurable intelligent surfaces can alter wave patterns to ensure consistent and high-quality signal reception no matter the user equipment (UE) location, including as a UE moves from time t₀ to time t₂, corresponding to a line-of-sight (LoS) location at time t₀ to non-LoS locations at times t₁ and t₂ covered by the reconfigurable intelligent surface 202(2).

It should be noted that in addition to outdoor deployments, reconfigurable intelligent surfaces can provide benefits in many other scenarios and applications. Indeed, the precise control over surface properties as described herein enables many other applications including, but not limited to, targeted medical imaging, cloaking and camouflaging.

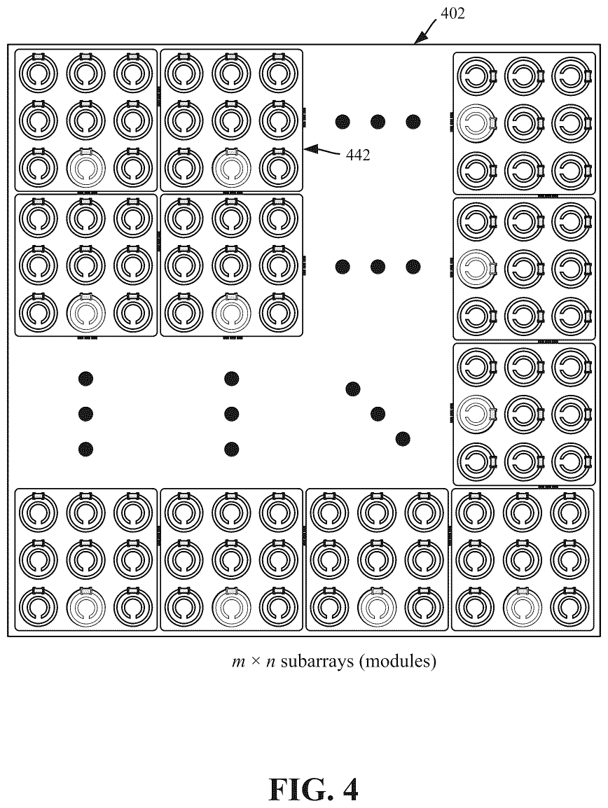

FIG. 4 is a representation of an example reconfigurable intelligent surface 402 assembled from modules of subarrays (e.g., of 3×3 unit cells) as described herein. One subarray 442 of the subarray modules is labeled; the other subarray modules are not labeled for purposes of clarity. Note that having subarrays that are modular is not a requirement, nor is having subarrays of the same size or the same number of unit cells in each dimension, however modular subarrays provide benefits in manufacturing, and symmetrical, same-sized subarrays simplify reflection pattern (e.g., closed-form equations) design and reflected signal strength design.

In FIG. 4, multiple modules of j×k (3×3 in this example) unit cells are connected together to form a higher order m×n reconfigurable intelligent surface array. A significant benefit of using this approach is scalability; larger reconfigurable intelligent surfaces with larger numbers of elements offer a higher gain to the reflected signal, and vice versa for less elements and lower gain. Hence, depending on the largest signal strength desired, the size of the reconfigurable intelligent surface can be scaled up or down based on the number of modules. For example, a small reconfigurable intelligent surface can be formed with the 2×2 array of modules (dashed block 550) or can be enlarged into an m×n array by adding modules. As little as a single module may be sufficient for some applications, e.g., if 25 unit cells are all that are needed for a low-signal strength application, a single 5×5 array of unit cells can be built into a module; (a “module” may not be needed; however an advantage of using a module as described herein allows for future expansion).

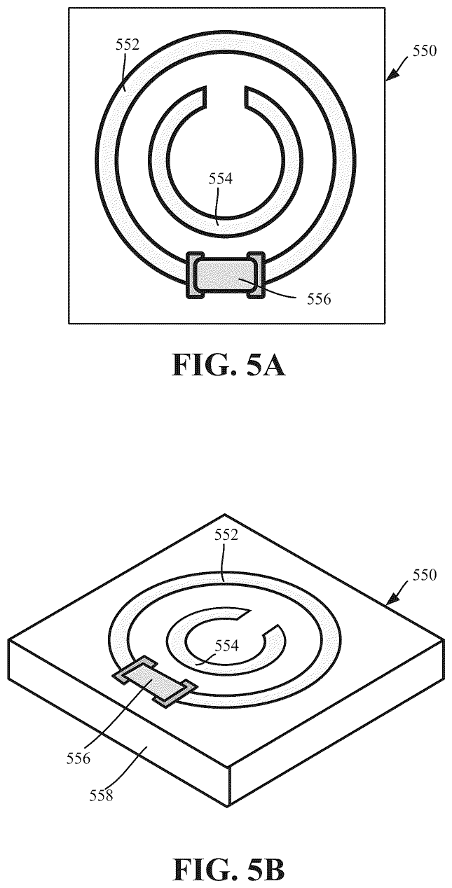

FIG. 5A shows an example design of a unit cell (or element) 550 that is part of a module, in which a unit cell is a basic building block of the reconfigurable intelligent surface. By understanding and performing controlled adjustment of each unit cell's properties, the system can predict and manage the overall behavior of the reconfigurable intelligent surface.

In the example nonlimiting implementation shown in FIGS. 5A (top view) and 5B (three-dimensional perspective view), one design of the unit cell 550 comprises two circular split rings 552 and 554. The outer ring 552 has a tunable device 556, e.g., an integrated varactor that offers a tunable capacitance with voltage. The dimensions of these rings 552 and 554 can be tailored to specific operational frequency ranges for which the unit cell is designed. As is understood, shapes other than circular split rings (e.g., square, rectangular and so on) and other configurations can be used in the construction of a unit cell. These elements can be designed on metallization layer on a (e.g., low-cost) substrate 558 (FIG. 2B).

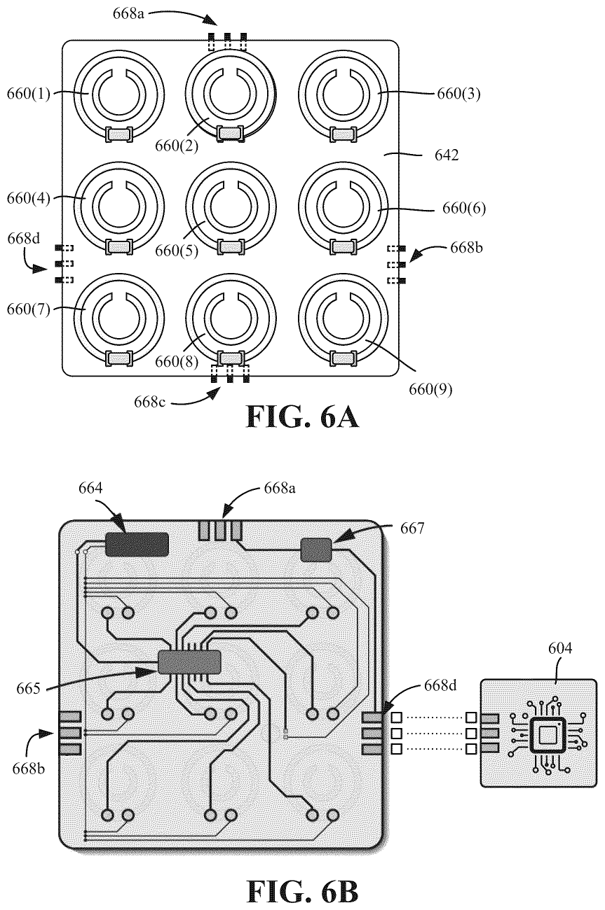

FIG. 6A shows a top view of an example array of nine unit cells 660(1)-660(9) combined in a 3×3 array on a module 642. Although a 3×3 array of unit cells per module are generally used in the examples herein, this is a nonlimiting example, and an array can be composed of j×k unit cells, where j and k are any practical numbers; (typically j=k, but this is not a requirement).

The element (unit cell) designs along with the surface mount devices (SMDs) such as varactors (not individually labeled) can be seen on the front side view of FIG. 6A. A power distribution module 664 and microcontroller 665, along with the metal traces (not separately labeled), provide the voltages to the nine varactors. An optional synchronization (sync) module 667 is shown, such as for facilitating any communication between subarrays. Coupling terminals 668 can be seen on the back side view in FIG. 6B of the module 642 for interconnecting modules, and for coupling the subarray 642 to a tile controller 604. The tile controller 604 (e.g., an FPGA (field programmable gate array) device) is thus shown as being coupled to the module 642, including for turning the module on or off via the microcontroller 665 as described herein, as well as (when turned on) having the microcontroller 665 tune the varactors to select the individual phases of the unit cells 660(1)-660(9).

Significantly, multiple of these modules can be coupled together to form a higher order array (as shown in FIG. 4 for example) using the coupling terminals 668a-668d (FIG. 6A), shown on each side of the module of FIG. 6A so that any vertically or horizontally adjacent module can be coupled thereto. Note that FIG. 6B omits depicting the coupling terminals 668c so as to avoid implying that they are electrically coupled to the varactor ground traces. The coupling terminals (collectively) 668 can be made of magnetic metals to facilitate both physical and electrical coupling.

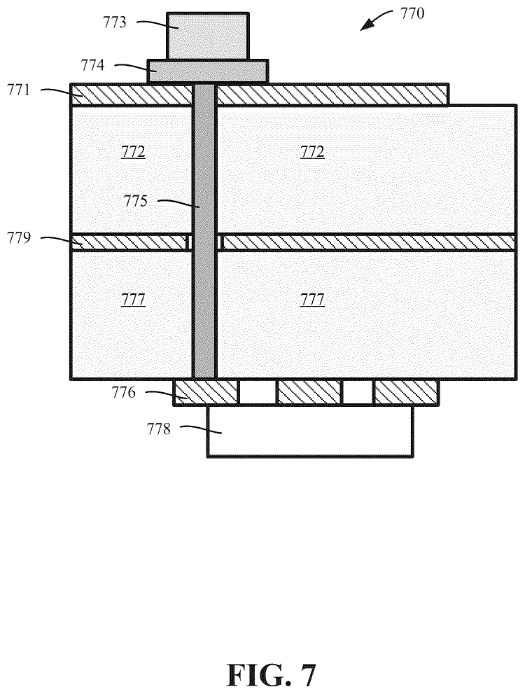

FIG. 7 shows a cross-sectional side view of a nonlimiting fabrication layer stack and arrangement of the unit cell 770. A top metallization layer 771 is patterned on a first substrate layer 772. The unit cells/elements are designed on each cell's metallization layer 771. The surface mounted device (SMD) tunable device (e.g., varactor) 773 can be soldered on top of SMD pads 774 atop the metallization layer 771, with a via 775 (e.g., for voltage control connections of the tunable device 773) to a bottom metallization layer 776 that couples to a microcontroller and power supply controller (PSU)/distribution module 778.

The underside of the first substrate layer 772 is separated from a second substrate layer 777 by a metal plane 779 acting as RF ground. Below the underside of the second substrate layer 778 is the bottom metallization layer 776 which is patterned to form the DC biasing and control circuitry, e.g., as in FIG. 6B. The controller and the PSU/power distribution module 778 are soldered on this bottom metallization layer 776. To ensure seamless interconnection across the multi-layered stack, the via 775 is strategically positioned. For instance, the tunable device 773 (e.g., varactor) is linked to two vias (only one via 775 is represented in the example of FIG. 7): one via connecting its negative terminal to the ground plane 779, while the other via links its positive terminal to the biasing on the bottom metal layer 776.

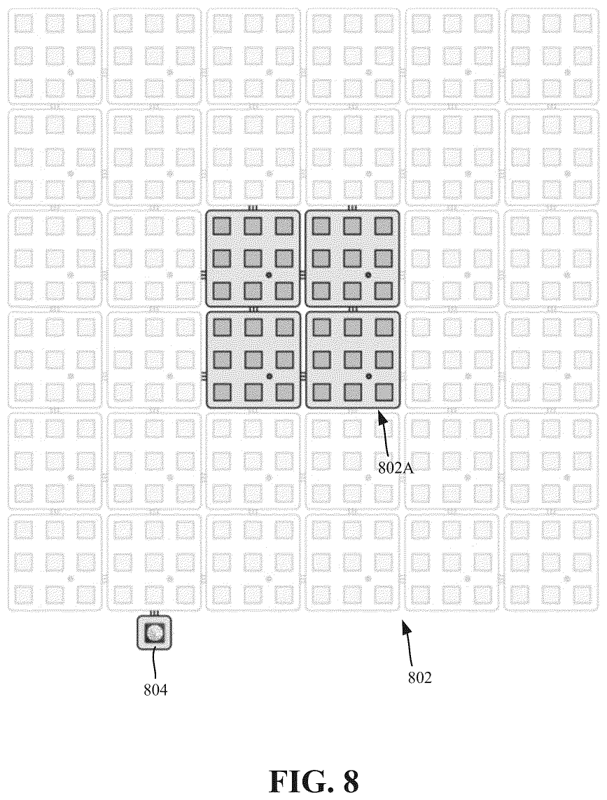

In general, as shown in FIG. 8, in which the unit cells of the modules are symbolically represented by squares, the coupling terminals facilitate modular connection of the subarrays of a reconfigurable intelligent surface 802; the small dots represent, for example, an optional receive antenna or other component per subarray. In the example FIG. 8, multiple modules of j×k (3×3 in this example) unit cells are connected together to form a higher order m×n subarrays (6×6 in this example) reconfigurable intelligent surface 802. A significant benefit of using this approach is the ability to select different aperture sizes by selectively turning on subarrays, up to the maximum number available. Hence, depending on the maximum signal strength desired, the size of the reconfigurable intelligent surface can be scaled up or down based on the number of modules, while the reflected signal strength can be reduced from maximum by turning on less than all subarrays.

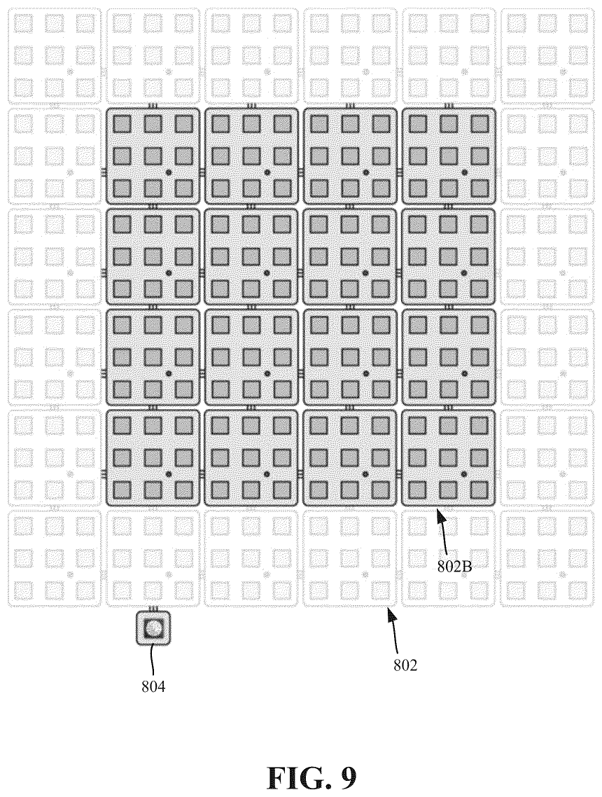

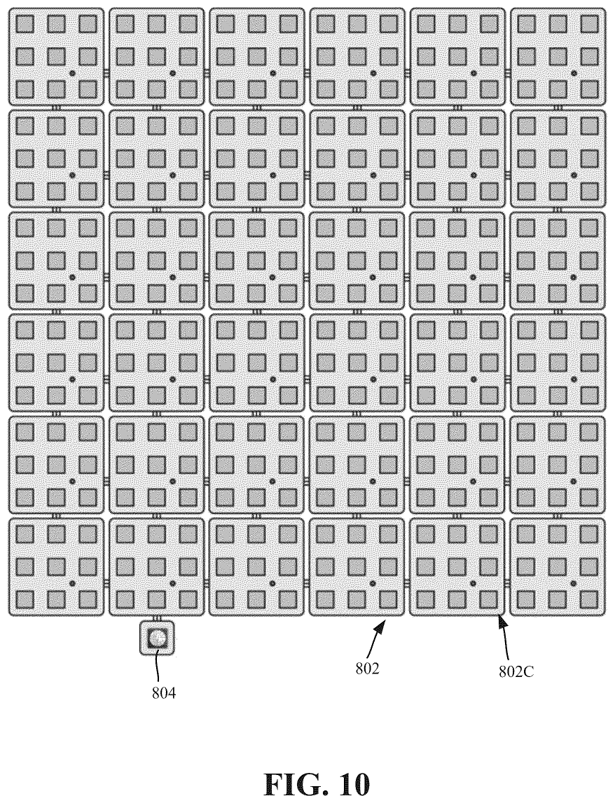

In the example of FIG. 8, in configuration 802A, only a 2×2 module array of the available subarrays of the reconfigurable intelligent surface 802 is turned to the ON state, by the tile controller 804, with respect to the reconfigurable intelligent surface's effective aperture coverage pattern. In configuration 802B as shown in FIG. 9, only a 4×4 module array is turned on, and in configuration 802C of FIG. 10, the entire 6×6 module array is turned on.

The gain provided to the reflected signal can be adjusted dynamically by the tile controller 804, using AI as described herein to determine the aperture size. Because the magnetic couplings are present on the modules, the tile controller 804 generally can be attached to any one module on the outer periphery of the reconfigurable intelligent surface 802.

The direction of the reflected signal from the active aperture arrays of the reconfigurable intelligent surface is dictated by a phase profile over the reconfigurable intelligent surface. The phase profile corresponds to how much phase shift each element in the reconfigurable intelligent surface presents, such that the phase shifts combine (e.g., constructively interfere) to reflect the incoming signal in the desired direction along with a certain gain. Closed-form equations can be used to determine the phase profiles for the expected reflected angle direction and gain for any a m×n reconfigurable intelligent surface array.

To change the phase shifts of each module's elements, the tile controller/AI model alters the voltage distributed to each of the varactors, which switches the varactors of the elements between capacitance states for elements within the currently selected aperture. As described above, the varactors can be surface mounted/soldered on the top surface with two vias per varactor to connect the diodes to the ground and the bottom layer, respectively.

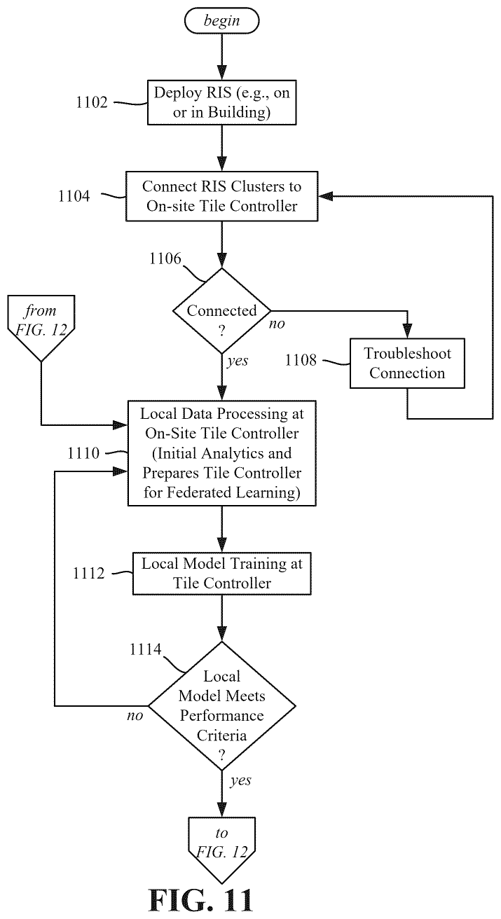

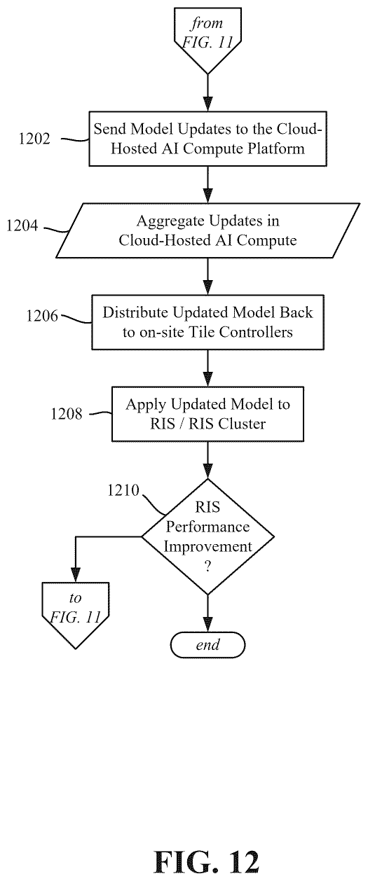

FIGS. 11 and 12 comprise a flow diagram showing example operations related to implementation of a reconfigurable intelligent surface, including model training operations of a tile controller model that configures the reconfigurable intelligent surface as described herein. Operation 1102 represents deploying the reconfigurable intelligent surface (RIS), e.g., on or in a building. Operation 1104 represents connecting the reconfigurable intelligent surface (e.g., as part of a cluster for the site) to an on-site tile controller. If not connected as evaluated by operation 1106, operation 1108 represents troubleshooting the connection until the issue is resolved.

At operation 1110, local data processing at on-site tile controller is performed, which in general applies initial analytics and prepares the local model for federated learning. Operation 1112 represents local model training of the on-site tile controller. As described herein, this trains the local model using on-site processed data.

Operation 1114 evaluates whether the local model meets performance criteria. If not, training continues iteratively until the local model meets the performance criteria. If so, the process continues to operation 1202 of FIG. 12.

Operation 1202 represents sending the model updates (following successful training/retraining) to the centralized controller, e.g., asynchronously to the cloud-hosted Al compute model/platform. To ensure data privacy, only the model updates are shared, not the raw data. Encryption can also be used of the model updates for more privacy, and compression prior to sending can be used for transmission efficiency.

Operation 1204 represents aggregating the updates in the centralized controller, e.g., the cloud-hosted Al compute model/platform. In this way, updates from all tile controllers managed by the centralized controller can be used to refine the global model, e.g., a large language model (LLM).

Operation 1206 represents the centralized controller distributing the updated global model back to the on-site tile controllers managed thereby. Operation 1208 represents the tile controller applying the updated model to this particular reconfigurable intelligent surface, as well as any other reconfigurable intelligent surface of the reconfigurable intelligent surface cluster managed by the tile controller.

Operation 1210 represents evaluating the reconfigurable intelligent surface for performance improvement for this reconfigurable intelligent surface based on the updated global model from the centralized controller (distributed to the tile controller). If the performance does not improve, operation 1210 returns to operation 1110 of FIG. 11 to redo the local model training; as can be seen, training and retraining continues until the local model meets performance criteria, and performance improves from the benefit of obtaining updated instance(s) of the global model.

If instead there is a performance improvement, the model is considered (for now) to be appropriately trained for this reconfigurable intelligent surface, and the tile controller uses the model to configure the reconfigurable intelligent surface for initial use. Note however that retraining of the local tile controller model with respect to this reconfigurable intelligent surface can be performed many times as described herein, generally improving the tile controller model as more information is learned over time.

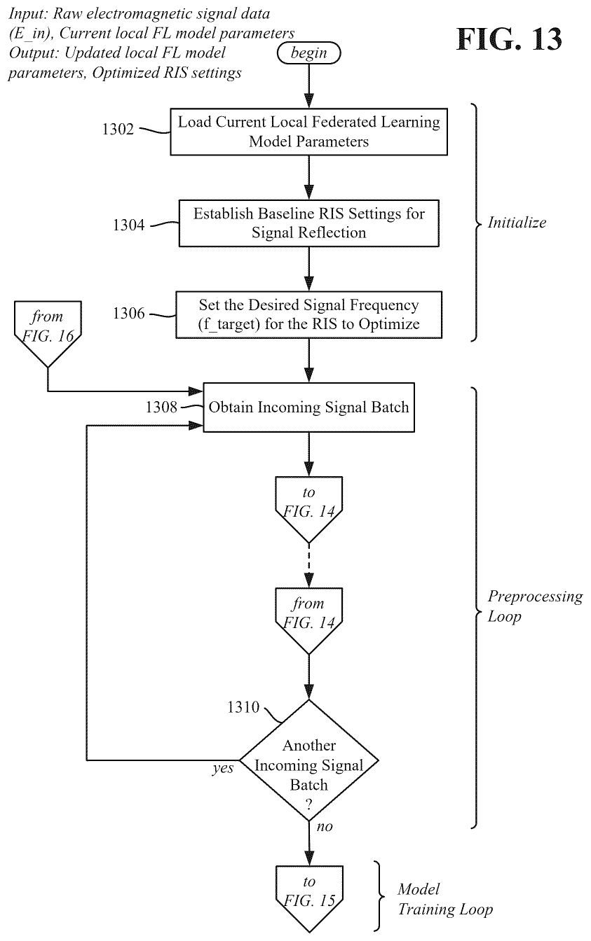

FIGS. 13-16 are a flow diagram of example operations showing additional details of local model training and signal processing at the local tile controller. The input data includes raw electromagnetic signal data (E_in), and current local federated learning (FL) model parameters. The output includes updated local FL model parameters, and optimized reconfigurable intelligent surface settings, that is, configuration data for the reconfigurable intelligent surface.

Initialization operations are represented by operations 1302, 1304 and 1306. More particularly, operation 1302 represents loading the current local federated learning model parameters. Operation 1304 represents establishing baseline reconfigurable intelligent surface settings for signal reflection. Operation 1306 sets the desired signal frequency (f_target) for the reconfigurable intelligent surface to optimize.

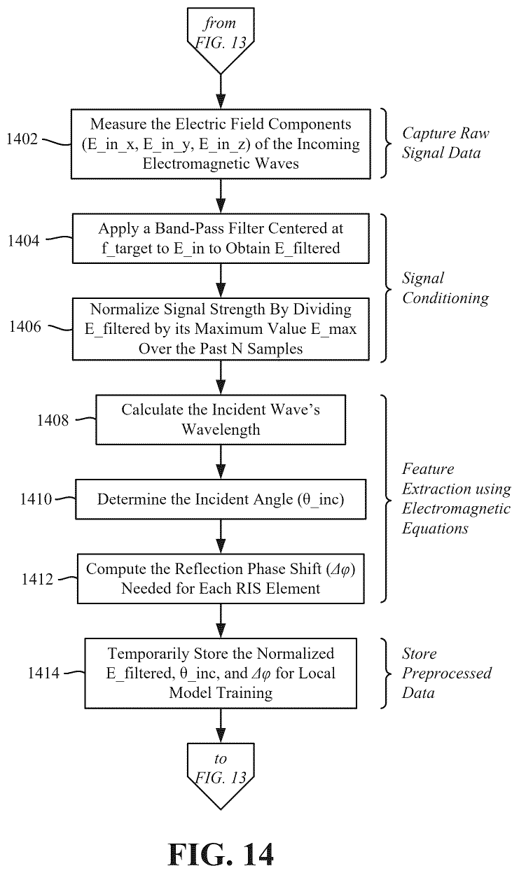

Preprocessing operations are represented by a loop via operations 1308 and 1310, which includes the operations of FIG. 14. Thus, for each incoming signal batch, operation 1308 of FIG. 13 captures the raw signal data (E_in: electric field vector of the incoming wave). Operation 1402 of FIG. 14 measures the electric field components (E_in_x, E_in_y, E_in_z) of the incoming electromagnetic waves.

Signal conditioning is next performed in the preprocessing loop, including operations 1404 and 1406 in this example. Operation 1404 applies a bandpass filter centered at the desired signal frequency (f_target) to the electric field vector E_in to obtain E_filtered vector data. Operation 1406 normalizes the signal strength by dividing E_filtered by its maximum value E_max over the past S samples.

Operations 1408, 1410 and 1412 are generally directed to feature extraction using electromagnetic equations. More particularly, operation 1408 calculates the incident wave's wavelength (λ) using λ=c/f_target, where c is the speed of light. Operation 1410 determines the incident angle (θ_inc) by taking the arc cos of the dot product of E_in direction and the normal to the reconfigurable intelligent surface plane, normalized by the magnitudes. Operation 1412 computes the reflection phase shift (Δφ) needed for each reconfigurable intelligent surface element using the equation:

$$Δφ = 2 π ( n λ + d ) / λ ,$$

where n is an integer, and d is the distance of the phase shift introduced by the reconfigurable intelligent surface.

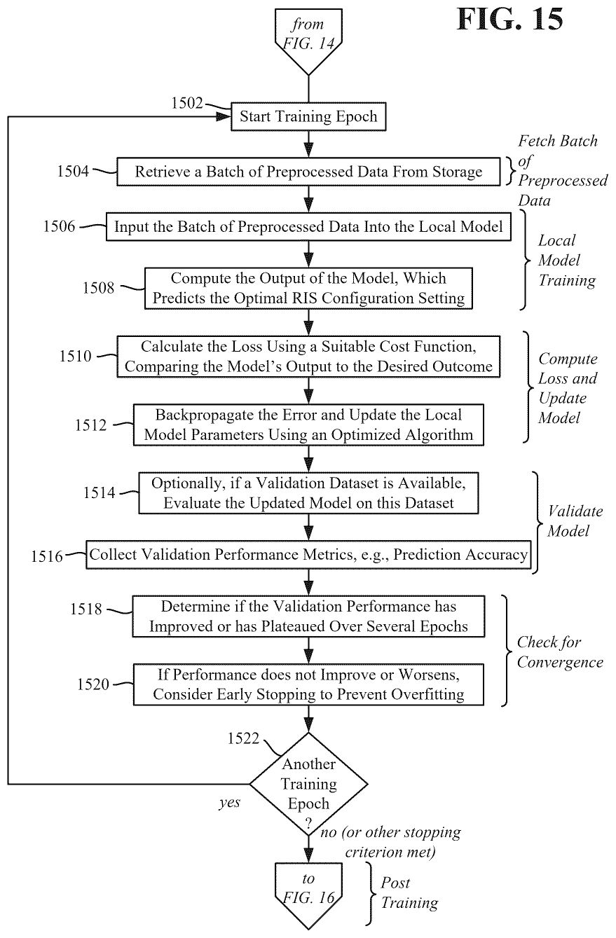

Operation 1414 stores the preprocessed data. In particular, operation 1414 temporarily stores the normalized E_filtered, θ_inc, and Δφ for local model training. The process returns to operation 1310 of FIG. 10 to repeat for each incoming signal batch, until there are none or some other stopping criterion is met, at which time operation 1310 branches to operation 1502 of FIG. 15.

In general, the operations of FIG. 15 are generally directed to a model training loop that iterates for each training epoch, or until a stopping criteria is met. Operation 1502 fetches a batch of preprocessed data, that is, retrieves a batch of preprocessed data from storage (a batch stored at operation 1414 of FIG. 14).

Operations 1506 and 1508 are generally directed to local model training. Operation 1506 represents inputting the batch of preprocessed data into the local model. Operation 1508 represents computing the output of the model, which predicts the optimal reconfigurable intelligent surface configuration settings.

Operations 1510 and 1512 are generally directed to computing the loss and updating the model. More particularly, operation 1510 calculates the loss using a suitable cost function, comparing the model's output to the desired outcome. Operation 1512 backpropagates the error and updates the local model parameters using an optimization algorithm (e.g., stochastic gradient descent).

If a validation dataset is available, (optional) operations 1514 and 1516 validate the model. Operation 1514 evaluates the updated model on the validation dataset. Operation 1516 collects validation performance metrics, such as prediction accuracy, for example.

Operations 1518 and 1520 are generally directed to checking for convergence. Operation 1518 determines if the validation performance has improved or if it has plateaued over several epochs. If performance is not improving or worsens (operation 1520), this can be considered as a stopping criterion for early stopping to prevent overfitting.

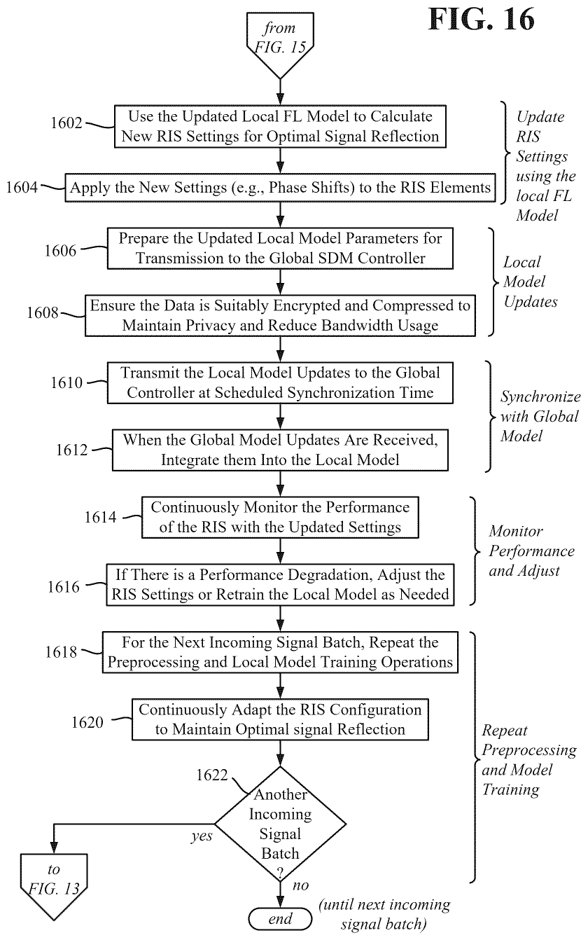

Operation 1522 repeats the local training for a new epoch with a different batch, or unless another stopping criterion is reached, e.g., corresponding to operation 1520. At this point, post-training is performed, as represented by the example operations of FIG. 16.

Operations 1602 and 1604 of FIG. 16 update the reconfigurable intelligent surface settings using the local federated learning (FL) model. Operation 1602 represents using the updated local federated learning model to calculate new reconfigurable intelligent surface settings for optimal signal reflection. More particularly, operation 1602 calculates the phase shifts (θ_RIS) for the reconfigurable intelligent surface elements to create a constructive interference pattern in the desired beam direction. The phase shifts θ_RIS are determined by (θ_RIS)=k*d*sin(θ_desired)−ΔΦ, where k=2π/λ is the wave number, d is the distance between reconfigurable intelligent surface elements, and θ_desired is the angle for the optimal signal direction. Operation 1604 applies the new settings to the reconfigurable intelligent surface elements, adjusting their phase shifts accordingly.

Operations 1606 and 1608 are generally directed to local model updates, in which operation 1606 prepares the updated local model parameters for transmission to the centralized (global) controller for this local tile controller. Operation 1608 represents the data being suitably encrypted and compressed to maintain privacy and reduce bandwidth usage.

Operations 1610 and 1612 are generally directed to synchronization with the global model. Operation 1610 transmits the local model updates to the global controller at the scheduled synchronization time. Operation 1612 represents, when the global model updates are received back, integrating them into the local model (as generally described with reference to operations 1206 and 1208 of FIG. 12).

Monitoring of the model performance and making adjustments are represented by operations 1614 and 1616. Operation 1614 represents (e.g., continuously) monitoring the performance of the reconfigurable intelligent surface with the updated settings. If there is a performance degradation, operation 1616 adjusts the reconfigurable intelligent surface settings or retrains the local model as needed.

Operations 1618 and 1620 repeat the preprocessing and model training. More particularly, operation 1618 represents, for the next incoming signal batch, repeating the preprocessing and local model training steps. Operation 1620 represents (e.g., continuously) adapting the reconfigurable intelligent surface configuration to maintain optimal signal reflection.

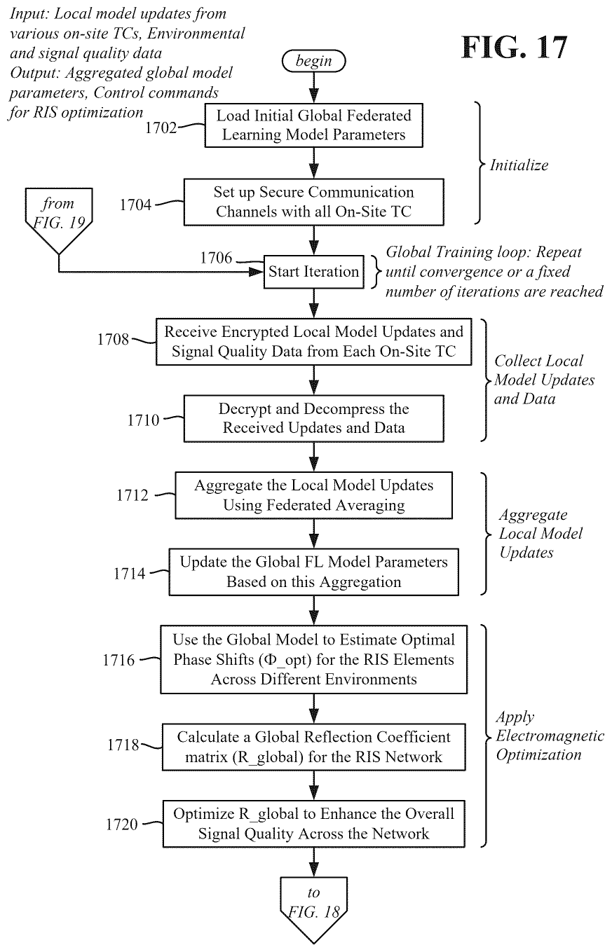

FIGS. 17-19 are a flow diagram of example operations related to the centralized controller, that is, the cloud-based software defined metasurface model for federated learning. The input data includes the local model updates from various on-site tile controllers (TCs), along with relevant environmental data and signal quality data. The output data includes the aggregated global model parameters, and control commands for reconfigurable intelligent surface optimization.

Initialization operations are represented by operations 1702 and 1704. More particularly, operation 1702 represents loading the initial global federated learning (FL) model parameters. Operation 1704 sets up secure communication channels with all of the on-site tile controllers managed by this centralized controller.

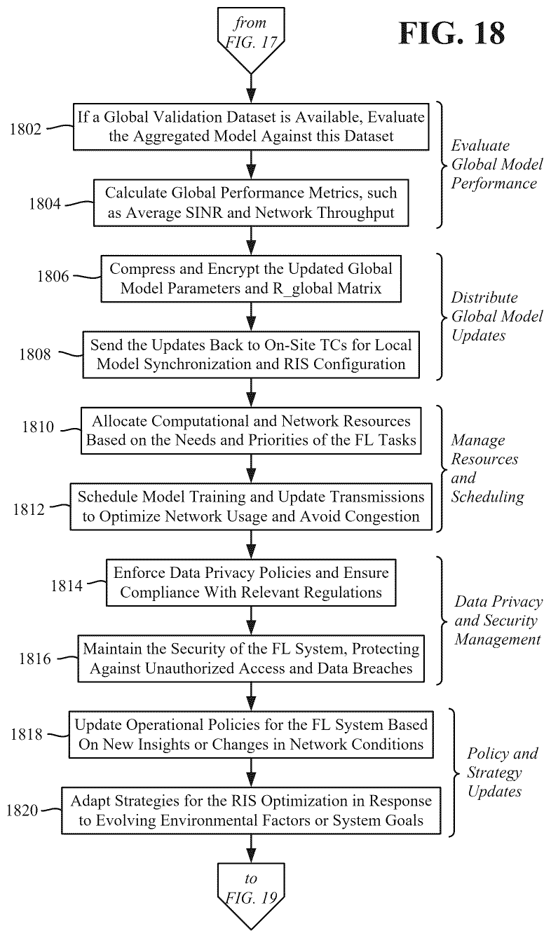

Operation 1706 starts a global training loop iteration, in which each iteration includes the rest of the example operations of FIG. 17, the example operations of FIG. 18, and operation 1902 of FIG. 9 (which repeats for a next iteration until convergence or a fixed number of iterations is reached). Operations 1708 and 1710 are generally directed to collecting local model updates and data.

More particularly, operation 1708 represents receiving encrypted local model updates and signal quality data (like SINR (signal-to-interference-plus-noise ratio), RSSI (received signal strength indicator), channel BER (bit error rate)) from each on-site tile controller (TC). Operation 1710 decrypts and decompresses the received updates and data.

Operations 1712 and 1714 are generally directed to aggregating local model updates. Operation 1712 aggregates the local model updates using federated averaging:

GlobalModelParams=Sum(LocalModelParams_i*Weight_i)/Sum(Weight_i),

where Weight_i can be based on the number of data samples, and/or performance metrics including SINR for tile controller_i. Operation 1714 represents updating the global federated learning model parameters based on this aggregation.

Operations 1716, 1718 and 1720 are generally directed to applying electromagnetic optimization. More particularly, operation 1716 uses the global model to estimate optimal phase shifts (Φ_opt) for the reconfigurable intelligent surface elements across different environments. Operation 1718 calculates a global reflection coefficient matrix (R_global) for the reconfigurable intelligent surface network, using R_global=f(Φ_opt, IncidentAngles, Wavelengths), where f is a function defining the relationship between phase shifts, incident angles, and signal wavelengths. Operation 1720 optimizes R_global to enhance the overall signal quality across the network.

The operations in this iteration of the global training loop continue at FIG. 18, where operations 1802 and 1804 of FIG. 18 are generally directed to evaluating the global model performance. If a global validation dataset is available, operation 1802 evaluates the aggregated model against this dataset. Operation 1804 calculates global performance metrics, such as average SINR and network throughput.

Operations 1806 and 1808 are generally directed to distributing global model updates. Operation 1806 represents compressing and encrypting the updated global model parameters and R_global matrix. Operation 1808 sends the updates back to on-site tile controllers (TCs) for local model synchronization and reconfigurable intelligent surface configuration.

Operations 1810 and 1812 represent managing resources and scheduling operations. Operation 1810 allocates computational and network resources based on the needs and priorities of the federated learning tasks. Operation 1812 schedules the model training and update transmissions, e.g., to optimize network usage and avoid congestion.

Operations 1814 and 1816 are generally directed to data privacy and security management. Operation 1814 represents enforcing data privacy policies and ensure compliance with relevant regulations. Operation 1816 represents maintaining the security of the federated learning (federated learning) system, protecting against unauthorized access and data breaches.

Operations 1818 and 1820 are generally directed to policy and strategy updates. Operation 1818 updates operational policies for the federated learning system based on new insights or changes in network conditions. Operation 1820 represents adapting strategies for the reconfigurable intelligent surface optimization in response to evolving environmental factors or system goals.

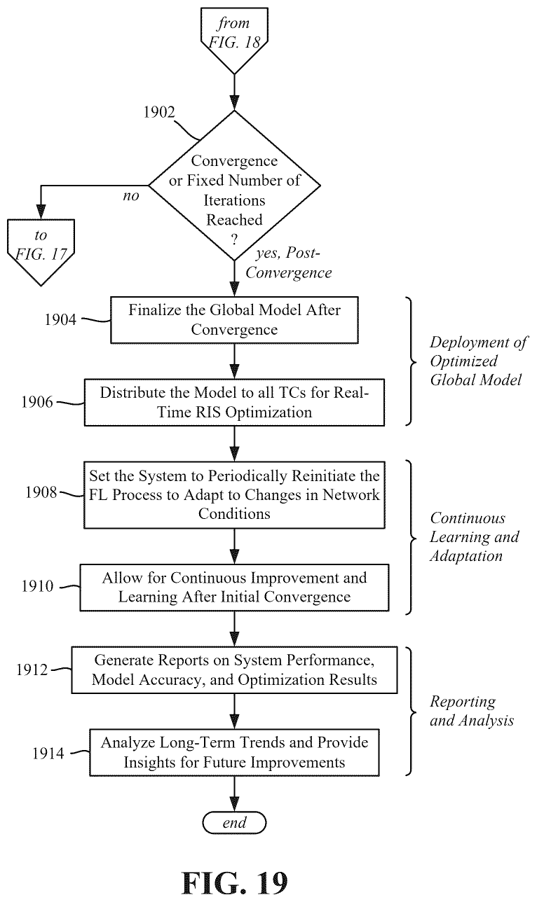

The operations in this iteration of the global training loop continue at FIG. 19, until operation 1902 of FIG. 19 ends the iterations upon convergence or a fixed number of iterations being reached. Note that until the iterations end, operation 1902 returns to operation 1706 of FIG. 17 which starts the next iteration.

Once the iterations have ended as determined at operation 1902, operations 1904-1914 are directed to post-convergence operations, in which operations 1904 and 1906 are generally directed to deployment of optimized global model. Operation 1904 represents finalizing the global model after convergence. Operation 1906 distributes the model to all tile controllers for real-time reconfigurable intelligent surface optimization.

Operations 1908 and 1910 are generally directed to continuous learning and adaptation. Operation 1908 sets the system to periodically (or otherwise) reinitiate the federated learning process to adapt to changes in network conditions. Operation 1910 is generally directed to allowing for continuous improvement and learning, even after initial convergence.

Operations 1912 and 1914 are generally directed to reporting and analysis. Operation 1912 represents generating reports on system performance, model accuracy, and optimization results. Operation 1914 represents analyzing long-term trends and providing insights for future improvements.

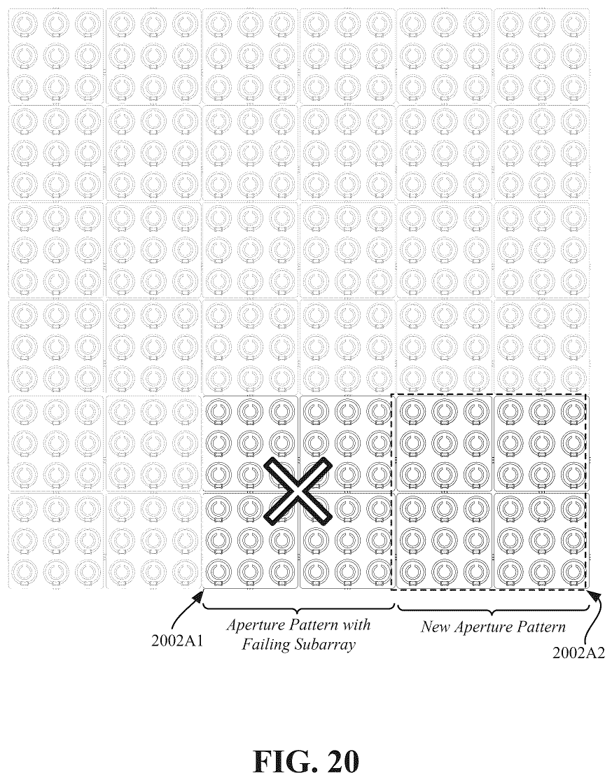

Once a trained instance of a local model is ready for use (e.g., after updating) at the on-site tile controller, in addition to determining signal strength (via aperture selection) and signal direction (via the unit cells' phases), the model can detect and repair (self-heal) the reconfigurable intelligent surface, at least to an extent. By way of example, consider that the model detects that an aperture pattern, such as shown at the bottom two rows of FIG. 20 as the 2×2 subarray aperture pattern 2002A1, has a failing subarray. This can be detected in various ways, including by observing that the measured performance regularly does not achieve near the performance of a different 2×2 subarray aperture pattern experiencing otherwise identical conditions, e.g., dynamically selected moments ago.

When a possible failure of a subarray is detected, the tile controller can select a different aperture with the same pattern, e.g., the 2×2 subarray aperture pattern 2002A2, thus self-healing the reconfigurable intelligent surface for any subarray aperture coverage pattern that does not need the subarray 2002A1. Note that if there is a relationship between how often a subarray is used before failure tends to occur, e.g., the components wear out from use, then it may make sense to generally locate smaller apertures in the corners or edges of the reconfigurable intelligent surface. For example, if a 2×2 subarray aperture in the middle of the reconfigurable intelligent surface (e.g., as in FIG. 8) fails, then it is not possible to boost the signal with a larger 3×3 or 4×4 subarray aperture of only non-failed subarrays, because any such larger subarray aperture would have to include the failed 2×2 subarray. However, if as in FIG. 20 the subarray aperture pattern 2002A1 fails, it is still possible to use a larger 3×3 or 4×4 subarray aperture in rows above the rows that include the failed aperture pattern 2002A1.

Still further, if it is practical to detect failing of an individual subarray, rather than detect failing of an entire aperture that includes the failing subarray, even more options are possible. For example, in FIG. 20 if the failing individual subarray is in the bottom row (or leftmost column, rightmost column or topmost row) of the reconfigurable intelligent surface, then an even larger 5×5 aperture can be used when appropriate by selecting the aperture without using the edge row or column that includes the failed subarray.

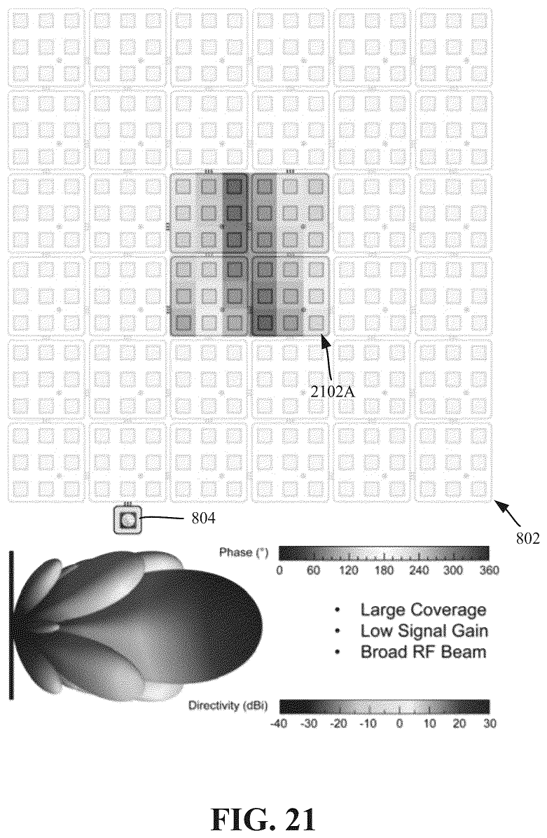

FIG. 21 generally corresponds to FIG. 8, configuration 802A (FIG. 8)/2102A (FIG. 21), in which the reconfigurable intelligent surface 802 has a smaller number of active cells (smaller aperture), which provides a lower gain that is less directional and covers a larger area. This is suitable in scenarios when user equipment (UEs) are distributed over a larger area, for example.

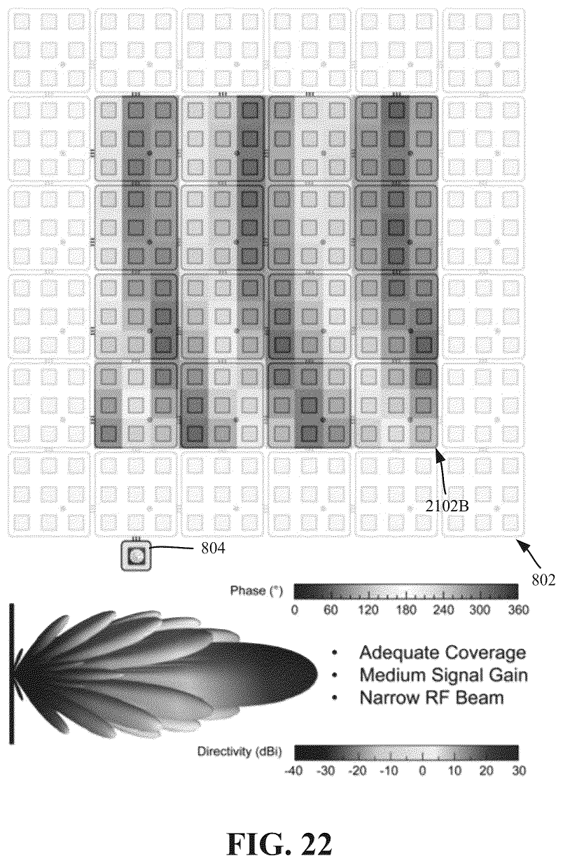

Increasing the reconfigurable intelligent surface aperture, as shown in configuration 802B (FIG. 9)/2102B (FIG. 22), enhances the signal gain while making the reflected RF beam relatively narrower. In FIG. 22, the increase in the number of active aperture cells (relative to FIG. 21) in the reconfigurable intelligent surface 802 provides a medium reflected signal gain and a narrower RF beam. Such a reconfigurable intelligent surface configuration can provide an adequate coverage area while users can take advantage of the higher signal gain in another example scenario.

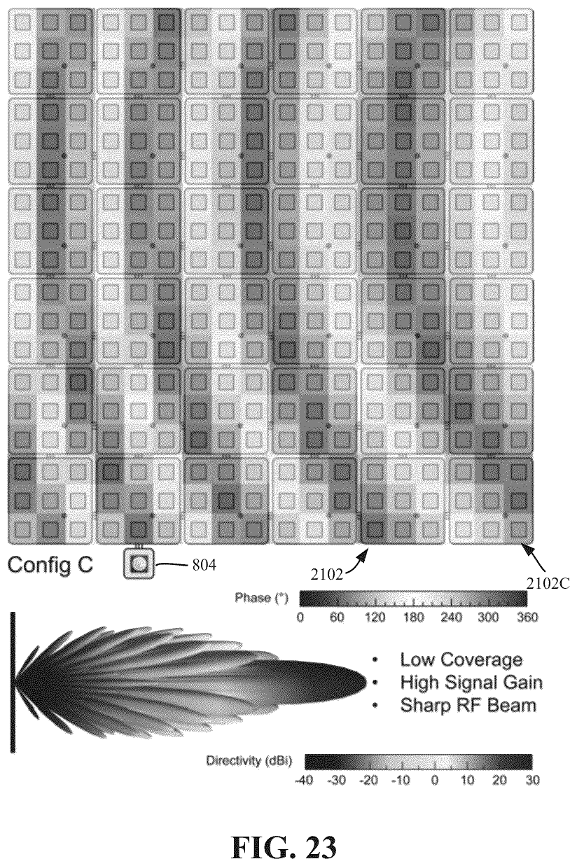

In FIG. 23, which generally corresponds to FIG. 10 configuration 802C, the reconfigurable intelligent surface aperture 2102C is increased even further relative to FIG. 23, resulting in a very sharp, directional RF beam as can be seen. In general, the phase profile spread over a large reconfigurable intelligent surface aperture provides a sharp reflected RF beam that offers very high signal gain but covers a smaller area. This is suitable for scenarios when UEs are clustered in a small area. As can be readily appreciated, FIGS. 21-23 depict only three nonlimiting examples, and other reconfigurable intelligent surfaces, such as with larger number of modules, can provide solutions for other scenarios.

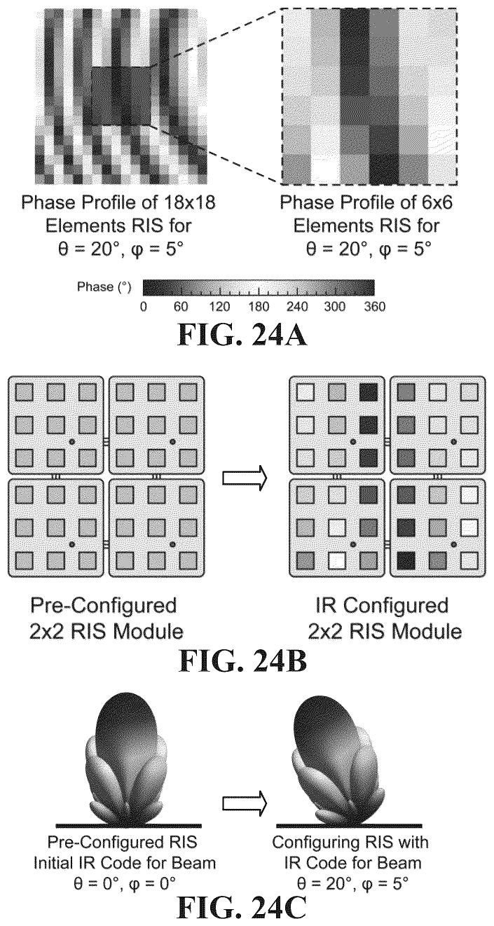

FIGS. 24A-24C show the phase profile for an 18×18 array reconfigurable intelligent surface corresponding to the reflected signal direction θ=20° (polar angle) and φ=5° (azimuth angle). As shown in FIG. 24A, a smaller section (a 6×6 array) from this phase profile provides the reflected signal in the same direction but with reduced signal gain. This phase profile is reflected on the 6×6 reconfigurable intelligent surface array in terms of voltage provided to the varactors. The reconfigurable intelligent surface panel is pre-configured to reflect in the direction θ=0° and φ=0°, and then can be reconfigured remotely in the desired direction (0=20° and φ=5°) based on the IR instruction code sent remotely from IR transmitter. FIG. 24B represents the preconfigured and post-IR signal-configured states of a 2×2 array of the modules, and FIG. 24C shows the beam directions in the respective preconfigured and post-IR signal-configured states.

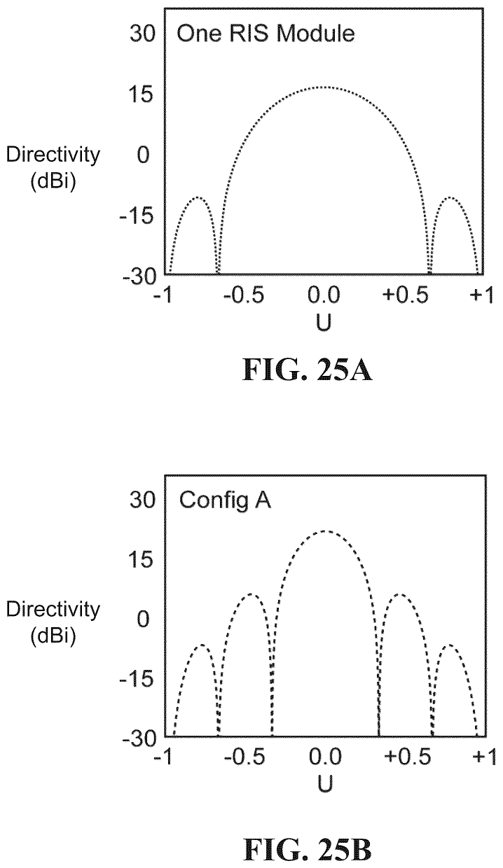

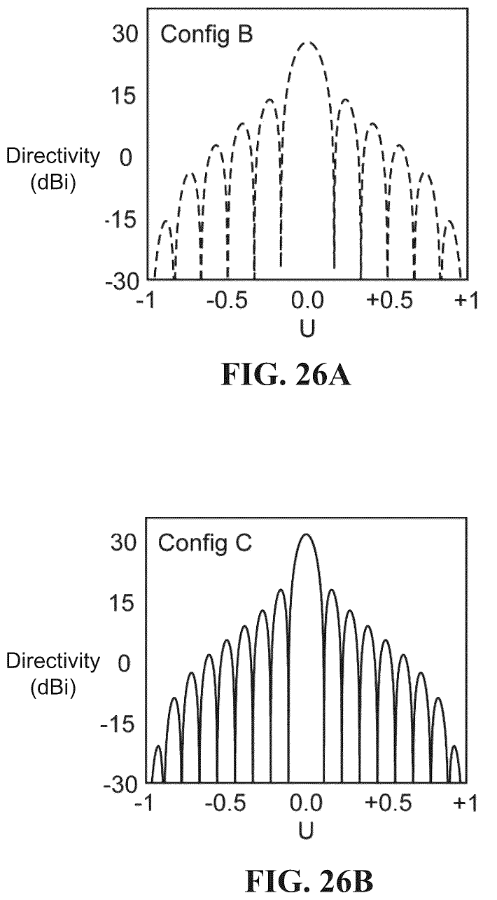

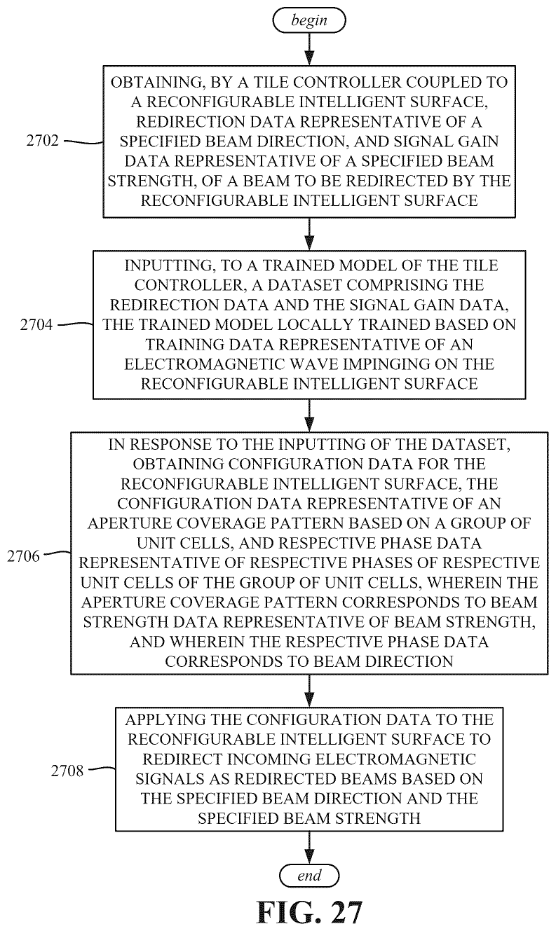

FIGS. 25A, 25B, 26A and 26B show the directivity diagrams of the reflected signal from the reconfigurable intelligent surface aperture in different configurations, namely with one reconfigurable intelligent surface module (3×3 array) (FIG. 25A), configuration “A” (6×6 array) (FIG. 25B), configuration “B” (12×12 array) (FIG. 26A), and configuration “C” (18×18 array) (FIG. 26B). As can be seen, as the number of elements is increased in the reconfigurable intelligent surface array, the signal gain consequently increases, while the main lobe of the reflected beam subsequently becomes narrower.

Turning to some example usage scenarios, consider that in many scenarios obstructions seriously impede the links between access points (APs) and users. For example, with smart office and home spaces, indoor environments are often cluttered with many obstructions, including walls, furniture, and appliances, which can block or degrade the millimeter wave (mmWave) wireless signals, which are high frequency signals. Reconfigurable intelligent surface panels can be strategically installed on walls, ceilings, or other surfaces/locations, and can be used to reflect and steer directly blocked mm Wave signals towards the shadow regions, thereby improving coverage. Thus, a reconfigurable intelligent surface can receive the mmWave signal from the indoor access point and redirect the signal to area(s) where the signal from the router is weak or non-existent.

As described herein, a reconfigurable intelligent surface can be reconfigured remotely using infrared control signals or the like. For example, a technician may be used to determine how many modules are needed for a reconfigurable intelligent surface, and where the reflected beam is to be directed for a given scenario. More modules than needed can be configured to allow for future expansion, with only the desired aperture active via gain control. The technician can enter a code/use a voice command and/or the like into the remote control, whereby the remote control sends the appropriate control signal to the modules, which then along with the primary controller reconfigure the reconfigurable intelligent surface accordingly. This configuration can remain in use (e.g., the technician takes the remote control) unless and until a change is deemed to be needed, whereby a technician can return to make the appropriate reconfiguration.

Moreover, the reconfigurable intelligent surface described herein not only improves the coverage but can also be used to improve the security of wireless communications. For example, by selectively directing signals, reconfigurable intelligent surfaces can minimize the possibility of eavesdropping. The passive beamforming from reconfigurable intelligent surface improves energy efficiency by reducing wasteful signal dispersion and directing the signal only where required. This concept can be easily extended to smart homes where reconfigurable intelligent surface can intelligently steer signals towards connected devices such as smart speakers, smart TVs, IoT (Internet of Things) sensors, and so on, even when these devices are located in hard-to-reach areas.

One or more implementations can be embodied in a system, such as represented in the example operations of FIG. 26, and for example can include at least one memory that stores computer executable components and/or operations, and at least one processor that executes computer executable components and/or operations stored in the memory. Example operations can include operation 2702, which represents obtaining, by a tile controller coupled to a reconfigurable intelligent surface, redirection data representative of a specified beam direction, and signal gain data representative of a specified beam strength, of a beam to be redirected by the reconfigurable intelligent surface. Example operation 2704 represents inputting, to a trained model of the tile controller, a dataset comprising the redirection data and the signal gain data, the trained model locally trained based on training data representative of an electromagnetic wave impinging on the reconfigurable intelligent surface. Example operation 2706 represents, in response to the inputting of the dataset, obtaining configuration data for the reconfigurable intelligent surface, the configuration data representative of an aperture coverage pattern based on a group of unit cells, and respective phase data representative of respective phases of respective unit cells of the group of unit cells, wherein the aperture coverage pattern corresponds to beam strength data representative of beam strength, and wherein the respective phase data corresponds to beam direction. Example operation 2708 represents applying the configuration data to the reconfigurable intelligent surface to redirect incoming electromagnetic signals as redirected beams based on the specified beam direction and the specified beam strength.

The respective unit cells of the reconfigurable intelligent surface can be arranged into subarrays of unit cells, the aperture coverage pattern can be a first aperture coverage pattern, and further operations can include obtaining feedback data representative of the redirected beams, learning, via the trained model based on the feedback data, that the first aperture pattern can include a potentially failing subarray, and changing, using the trained model, the first aperture pattern to a second aperture pattern corresponding to the specified beam strength to avoid use of the potentially failing subarray.

The training data, on which the trained model can be locally trained, can include federated learning data obtained by the tile controller from a centralized controller that manages the tile controller and at least one other tile controller.

Further operations further can include training the trained model; the training can include extracting feature data representative of the electromagnetic wave impinging on the reconfigurable intelligent surface, the feature data can include incident angle data representative of an incident angle of the electromagnetic wave and wavelength data representative of a wavelength of the incoming electromagnetic wave, determining, based on the feature data, respective reflection phase shift angle data representative of respective reflection phase shift angles of selected respective unit cells of the reconfigurable intelligent surface, inputting a batch dataset comprising the incident angle data, the wavelength data, and the respective reflection phase shift angle data into the trained model coupled to the controller to obtain predicted configuration data representative of a predicted configuration, and determining a loss value representative of the predicted configuration data compared to target configuration data representative of a target configuration. The electromagnetic wave impinging on the reconfigurable intelligent surface can include raw signal data representative of a raw signal, and further operations can include, prior to the extracting of the feature data, performing signal conditioning on the raw signal data, which can include at least one of: filtering the raw signal data to obtain filtered signal data representative of a filtered signal, normalizing a first signal strength of the raw signal data to obtain normalized signal data representative of a normalized signal, or normalizing a second signal strength of the filtered signal data to obtain normalized filtered signal data representative of a normalized filtered signal.

Further operations can include updating model parameters to obtain different predicted configuration data representative of a different predicted configuration, different from the predicted configuration, that reduces the loss value to specified validation performance metric data, corresponding to updated model parameters. Further operations can include transmitting the updated model parameters to a centralized controller that manages the tile controller and at least one other tile controller. Further operations can include encrypting the updated model parameters prior to transmitting the updated model parameters to the centralized controller.

Further operations can include performing federated learning by the centralized controller, comprising aggregating the updated model parameters from the tile controller and other updated model parameters from the at least one other tile controller to obtain global model parameters, learning a global model from the global model parameters, and distributing the global model to the tile controller and the at least one other tile controller.

The redirection data can be first redirection data representative of a first specified beam direction, the dataset can be a first dataset, the configuration data can be first configuration data, the respective phase data can be first respective phase data representative of first respective phases of the respective unit cells, and further operations can include obtaining second redirection data representative of a second specified beam direction, inputting, to the trained model of the tile controller, a second dataset comprising the second redirection data and the signal gain data, in response to the inputting of the second dataset, obtaining second configuration data for the reconfigurable intelligent surface, the second configuration data representative of the aperture coverage pattern, and second respective phase data representative of second respective phases of the respective unit cells of the group of unit cells, and applying the second configuration data to the reconfigurable intelligent surface to redirect further incoming electromagnetic signals as further redirected beams based on the second specified beam direction and the specified beam strength.

The signal gain data can be first signal gain data representative of a first specified beam strength, the dataset can be a first dataset, the configuration data can be first configuration data, the aperture coverage pattern can be a first aperture coverage pattern, and further operations can include obtaining second signal gain data representative of a second specified beam direction, inputting, to the trained model of the tile controller, a second dataset comprising the redirection data and the second signal gain data, in response to the inputting of the second dataset, obtaining second configuration data for the reconfigurable intelligent surface, the second configuration data representative of a second aperture coverage pattern, and the respective phase data of the respective unit cells of the group of unit cells, and applying the second configuration data to the reconfigurable intelligent surface to redirect further incoming electromagnetic signals as further redirected beams based on the specified beam direction and the second specified beam strength.

The redirection data can be first redirection data representative of a first specified beam direction, the signal gain data can be first signal gain data representative of a first specified beam strength, wherein the dataset can be a first dataset, the configuration data can be first configuration data, the respective phase data can be first respective phase data representative of first respective phases of the respective unit cells, the aperture coverage pattern can be a first aperture coverage pattern, and further operations can include obtaining second redirection data representative of a second specified beam direction, obtaining second signal gain data representative of a second specified beam direction, inputting, to the trained model of the tile controller, a second dataset comprising the second redirection data and the second signal gain data, in response to the inputting of the second dataset, obtaining second configuration data for the reconfigurable intelligent surface, the second configuration data representative of the second aperture coverage pattern, and second respective phase data representative of second respective phases of the respective unit cells of the group of unit cells, and applying the second configuration data to the reconfigurable intelligent surface to redirect further incoming electromagnetic signals as further redirected beams based on the second specified beam direction and the second specified beam strength.

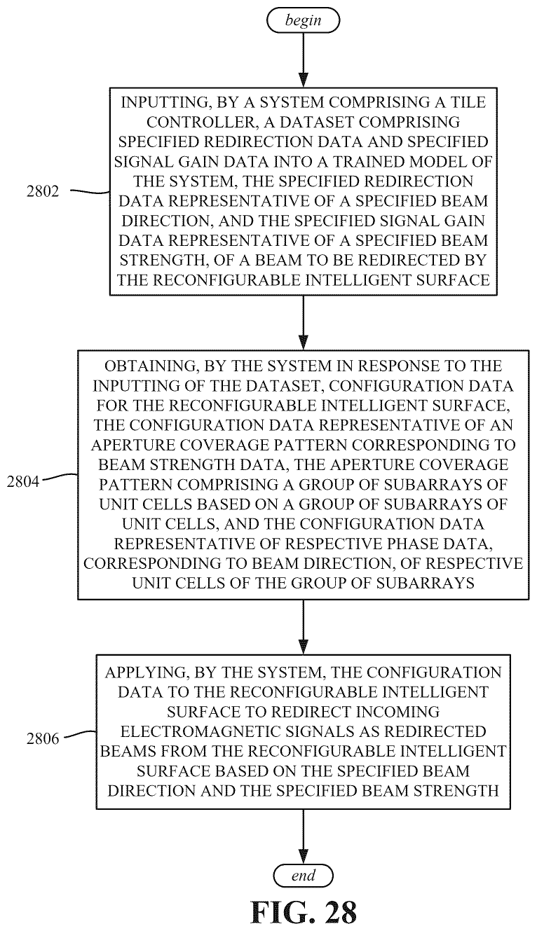

One or more example implementations and embodiments, such as corresponding to example operations of a method, are represented in FIG. 28. Example operation 2802 represents inputting, by a system comprising a tile controller, a dataset comprising specified redirection data and specified signal gain data into a trained model of the system, the specified redirection data representative of a specified beam direction, and the specified signal gain data representative of a specified beam strength, of a beam to be redirected by the reconfigurable intelligent surface. Example operation 2802 represents obtaining, by the system in response to the inputting of the dataset, configuration data for the reconfigurable intelligent surface, the configuration data representative of an aperture coverage pattern corresponding to beam strength data, the aperture coverage pattern comprising a group of subarrays of unit cells based on a group of subarrays of unit cells, and the configuration data representative of respective phase data, corresponding to beam direction, of respective unit cells of the group of subarrays. Example operation 2806 represents applying, by the system, the configuration data to the reconfigurable intelligent surface to redirect incoming electromagnetic signals as redirected beams from the reconfigurable intelligent surface based on the specified beam direction and the specified beam strength.

The aperture coverage pattern can be a first aperture coverage pattern, and further operations can include obtaining, by the system, feedback data representative of the redirected beams, learning, by the trained model based on the feedback data, that the first aperture pattern can include a potentially failing subarray, and changing, by the trained model, the first aperture pattern to a second aperture pattern corresponding to the specified beam strength to avoid use of the potentially failing subarray.

Further operations can include receiving, by the system, global model data from a centralized controller coupled to the tile controller, and updating the trained model based on the global model data.

The dataset can be a first dataset, the redirection data can be first redirection data, the specified signal gain data can be first specified signal gain data, and the configuration data can be first configuration data, and further operations can include inputting, by the system, a second dataset into the trained model; the second dataset can include at least one of: second specified redirection data that can be different from the first redirection data, or second specified signal gain data that can be different from the first specified signal gain data, obtaining, by the system in response to the inputting of the second dataset, second configuration data for the reconfigurable intelligent surface, and applying, by the system, the second configuration data to the reconfigurable intelligent surface to redirect further incoming electromagnetic signals as further redirected beams from the reconfigurable intelligent surface based on: the second specified beam direction and the first specified beam strength, the first specified beam direction and the second specified beam strength, or the second specified beam direction and the second specified beam strength.

Further operations can include receiving, by the system, by the system, feedback data representative of the redirected beams, and updating the trained model based on the feedback data.

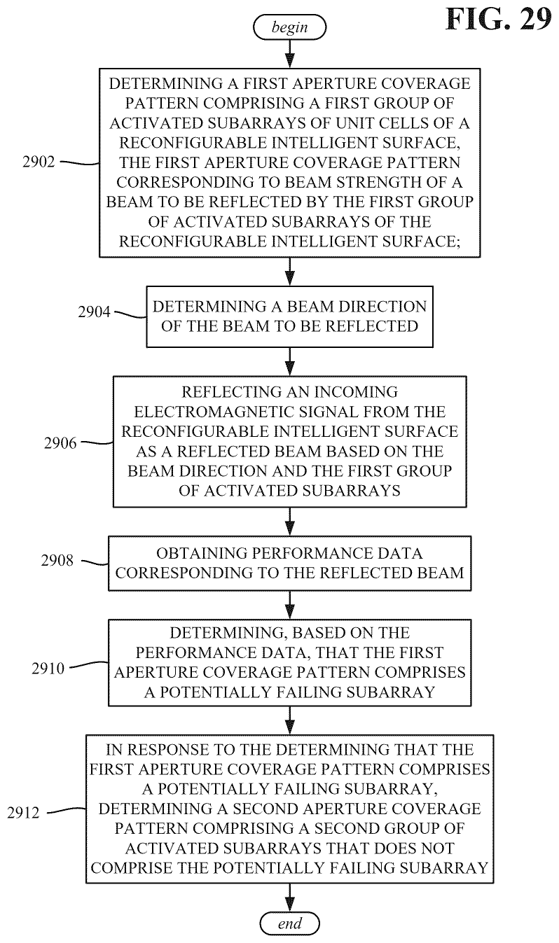

FIG. 29 summarizes various example operations, e.g., corresponding to a machine-readable medium, comprising executable instructions that, when executed by at least one processor, facilitate performance of operations. Example operation 2902 represents determining a first aperture coverage pattern comprising a first group of activated subarrays of unit cells of a reconfigurable intelligent surface, the first aperture coverage pattern corresponding to beam strength of a beam to be reflected by the first group of activated subarrays of the reconfigurable intelligent surface. Example operation 2904 represents determining a beam direction of the beam to be reflected. Example operation 2906 represents reflecting an incoming electromagnetic signal from the reconfigurable intelligent surface as a reflected beam based on the beam direction and the first group of activated subarrays. Example operation 2908 represents obtaining performance data corresponding to the reflected beam. Example operation 2910 represents determining, based on the performance data, that the first aperture coverage pattern can include a potentially failing subarray. Example operation 2912 represents in response to the determining that the first aperture coverage pattern can include a potentially failing subarray, determining a second aperture coverage pattern comprising a second group of activated subarrays that does not can include the potentially failing subarray.

The beam direction can be a first beam direction, wherein the incoming electromagnetic signal can be a first incoming electromagnetic signal, wherein the reflected beam can be a first reflected beam, and further operations can include determining a second beam direction of a second beam to be reflected by the reconfigurable intelligent surface, and reflecting a second incoming electromagnetic signal from the reconfigurable intelligent surface as a second reflected beam based on the second beam direction and the second group of activated subarrays.

Determining that the first aperture coverage pattern comprises a potentially failing subarray can be performed by a trained model.

As can be seen, the technology described herein facilitates adaptive shaping of reconfigurable intelligent surfaces' geometries, with decentralized learning in combination with federated learning to make reconfigurable intelligent surfaces operationally more efficient. The adaptive functionality by way of on-demand reconfiguration allows a reconfigurable intelligent surface to adapt to different operating conditions and fulfill diverse tasks efficiently, repairing itself in case of failures of one or more subarrays of unit cells.

Dynamic geometry adjustment is facilitated by real-time optimization of the surface geometry, including optimization based on distributed intelligence in a centralized (e.g., software defined metasurface (SDM) controller and multiple tile controllers, which leads to improved beamforming, focusing, and signal transmission efficiency in communication systems. Further benefits include proactive maintenance and reduced downtime, in that early detection and isolation of failing components (tiles) can prevent performance degradation and extend the lifespan of the reconfigurable intelligent surface. Such proactive health monitoring and self-healing reduces maintenance costs by reducing the need for manual interventions and associated costs.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
obtaining, by a tile controller coupled to a reconfigurable intelligent surface, redirection data representative of a specified beam direction, and signal gain data representative of a specified beam strength, of a beam to be redirected by the reconfigurable intelligent surface;
inputting, to a trained model of the tile controller, a dataset comprising the redirection data and the signal gain data, the trained model locally trained based on training data representative of an electromagnetic wave impinging on the reconfigurable intelligent surface;
in response to the inputting of the dataset, obtaining configuration data for the reconfigurable intelligent surface, the configuration data representative of an aperture coverage pattern based on a group of unit cells, and respective phase data representative of respective phases of respective unit cells of the group of unit cells, wherein the aperture coverage pattern corresponds to beam strength data representative of beam strength, and wherein the respective phase data corresponds to beam direction; and
applying the configuration data to the reconfigurable intelligent surface to redirect incoming electromagnetic signals as redirected beams based on the specified beam direction and the specified beam strength.

2. The system of claim 1, wherein the respective unit cells of the reconfigurable intelligent surface are arranged into subarrays of unit cells, wherein the aperture coverage pattern is a first aperture coverage pattern, and wherein the operations further comprise obtaining feedback data representative of the redirected beams, learning, via the trained model based on the feedback data, that the first aperture pattern comprises a potentially failing subarray, and changing, using the trained model, the first aperture pattern to a second aperture pattern corresponding to the specified beam strength to avoid use of the potentially failing subarray.

3. The system of claim 1, wherein the training data, on which the trained model is locally trained, comprises federated learning data obtained by the tile controller from a centralized controller that manages the tile controller and at least one other tile controller.

4. The system of claim 1, wherein the operations further comprise training the trained model, the training comprising extracting feature data representative of the electromagnetic wave impinging on the reconfigurable intelligent surface, the feature data comprising incident angle data representative of an incident angle of the electromagnetic wave and wavelength data representative of a wavelength of the incoming electromagnetic wave, determining, based on the feature data, respective reflection phase shift angle data representative of respective reflection phase shift angles of selected respective unit cells of the reconfigurable intelligent surface, inputting a batch dataset comprising the incident angle data, the wavelength data, and the respective reflection phase shift angle data into the trained model coupled to the controller to obtain predicted configuration data representative of a predicted configuration, and determining a loss value representative of the predicted configuration data compared to target configuration data representative of a target configuration.

5. The system of claim 4, wherein the electromagnetic wave impinging on the reconfigurable intelligent surface comprises raw signal data representative of a raw signal, and wherein the operations further comprise, prior to the extracting of the feature data, performing signal conditioning on the raw signal data, comprising at least one of: filtering the raw signal data to obtain filtered signal data representative of a filtered signal, normalizing a first signal strength of the raw signal data to obtain normalized signal data representative of a normalized signal, or normalizing a second signal strength of the filtered signal data to obtain normalized filtered signal data representative of a normalized filtered signal.

6. The system of claim 4, wherein the operations further comprise updating model parameters to obtain different predicted configuration data representative of a different predicted configuration, different from the predicted configuration, that reduces the loss value to specified validation performance metric data, corresponding to updated model parameters.

7. The system of claim 6, wherein the operations further comprise transmitting the updated model parameters to a centralized controller that manages the tile controller and at least one other tile controller.

8. The system of claim 7, wherein the operations further comprise encrypting the updated model parameters prior to transmitting the updated model parameters to the centralized controller.

9. The system of claim 7, wherein the operations further comprise performing federated learning by the centralized controller, comprising aggregating the updated model parameters from the tile controller and other updated model parameters from the at least one other tile controller to obtain global model parameters, learning a global model from the global model parameters, and distributing the global model to the tile controller and the at least one other tile controller.

10. The system of claim 1, wherein the redirection data is first redirection data representative of a first specified beam direction, wherein the dataset is a first dataset, wherein the configuration data is first configuration data, wherein the respective phase data is first respective phase data representative of first respective phases of the respective unit cells, and wherein the operations further comprise:
obtaining second redirection data representative of a second specified beam direction,
inputting, to the trained model of the tile controller, a second dataset comprising the second redirection data and the signal gain data,
in response to the inputting of the second dataset, obtaining second configuration data for the reconfigurable intelligent surface, the second configuration data representative of the aperture coverage pattern, and second respective phase data representative of second respective phases of the respective unit cells of the group of unit cells, and
applying the second configuration data to the reconfigurable intelligent surface to redirect further incoming electromagnetic signals as further redirected beams based on the second specified beam direction and the specified beam strength.

11. The system of claim 1, wherein the signal gain data is first signal gain data representative of a first specified beam strength, wherein the dataset is a first dataset, wherein the configuration data is first configuration data, wherein the aperture coverage pattern is a first aperture coverage pattern, and wherein the operations further comprise:
obtaining second signal gain data representative of a second specified beam direction,
inputting, to the trained model of the tile controller, a second dataset comprising the redirection data and the second signal gain data,
in response to the inputting of the second dataset, obtaining second configuration data for the reconfigurable intelligent surface, the second configuration data representative of a second aperture coverage pattern, and the respective phase data of the respective unit cells of the group of unit cells, and
applying the second configuration data to the reconfigurable intelligent surface to redirect further incoming electromagnetic signals as further redirected beams based on the specified beam direction and the second specified beam strength.

12. The system of claim 1, wherein the redirection data is first redirection data representative of a first specified beam direction, wherein the signal gain data is first signal gain data representative of a first specified beam strength, wherein the dataset is a first dataset, wherein the configuration data is first configuration data, wherein the respective phase data is first respective phase data representative of first respective phases of the respective unit cells, wherein the aperture coverage pattern is a first aperture coverage pattern, and wherein the operations further comprise:
obtaining second redirection data representative of a second specified beam direction,
obtaining second signal gain data representative of a second specified beam direction,
inputting, to the trained model of the tile controller, a second dataset comprising the second redirection data and the second signal gain data,
in response to the inputting of the second dataset, obtaining second configuration data for the reconfigurable intelligent surface, the second configuration data representative of the second aperture coverage pattern, and second respective phase data representative of second respective phases of the respective unit cells of the group of unit cells, and
applying the second configuration data to the reconfigurable intelligent surface to redirect further incoming electromagnetic signals as further redirected beams based on the second specified beam direction and the second specified beam strength.

13. A method, comprising:
inputting, by a system comprising a tile controller, a dataset comprising specified redirection data and specified signal gain data into a trained model of the system, the specified redirection data representative of a specified beam direction, and the specified signal gain data representative of a specified beam strength, of a beam to be redirected by the reconfigurable intelligent surface;
obtaining, by the system in response to the inputting of the dataset, configuration data for the reconfigurable intelligent surface, the configuration data representative of an aperture coverage pattern corresponding to beam strength data, the aperture coverage pattern comprising a group of subarrays of unit cells based on a group of subarrays of unit cells, and the configuration data representative of respective phase data, corresponding to beam direction, of respective unit cells of the group of subarrays; and
applying, by the system, the configuration data to the reconfigurable intelligent surface to redirect incoming electromagnetic signals as redirected beams from the reconfigurable intelligent surface based on the specified beam direction and the specified beam strength.

14. The method of claim 13, wherein the aperture coverage pattern is a first aperture coverage pattern, and further comprising obtaining, by the system, feedback data representative of the redirected beams, learning, by the trained model based on the feedback data, that the first aperture pattern comprises a potentially failing subarray, and changing, by the trained model, the first aperture pattern to a second aperture pattern corresponding to the specified beam strength to avoid use of the potentially failing subarray.

15. The method of claim 13, further comprising receiving, by the system, global model data from a centralized controller coupled to the tile controller, and updating the trained model based on the global model data.

16. The method of claim 13, wherein the dataset is a first dataset, wherein the redirection data is first redirection data, wherein the specified signal gain data is first specified signal gain data, and wherein the configuration data is first configuration data, and further comprising:
inputting, by the system, a second dataset into the trained model, wherein the second dataset comprises at least one of: second specified redirection data that is different from the first redirection data, or second specified signal gain data that is different from the first specified signal gain data,
obtaining, by the system in response to the inputting of the second dataset, second configuration data for the reconfigurable intelligent surface, and
applying, by the system, the second configuration data to the reconfigurable intelligent surface to redirect further incoming electromagnetic signals as further redirected beams from the reconfigurable intelligent surface based on: the second specified beam direction and the first specified beam strength, the first specified beam direction and the second specified beam strength, or the second specified beam direction and the second specified beam strength.

17. The method of claim 13, further comprising receiving, by the system, by the system, feedback data representative of the redirected beams, and updating the trained model based on the feedback data.

18. A non-transitory machine-readable medium, comprising executable instructions that, when executed by at least one processor, facilitate performance of operations, the operations comprising:
determining a first aperture coverage pattern comprising a first group of activated subarrays of unit cells of a reconfigurable intelligent surface, the first aperture coverage pattern corresponding to beam strength of a beam to be reflected by the first group of activated subarrays of the reconfigurable intelligent surface;
determining a beam direction of the beam to be reflected;
reflecting an incoming electromagnetic signal from the reconfigurable intelligent surface as a reflected beam based on the beam direction and the first group of activated subarrays;
obtaining performance data corresponding to the reflected beam;
determining, based on the performance data, that the first aperture coverage pattern comprises a potentially failing subarray; and
in response to the determining that the first aperture coverage pattern comprises a potentially failing subarray, determining a second aperture coverage pattern comprising a second group of activated subarrays that does not comprise the potentially failing subarray.

19. The non-transitory machine-readable medium of claim 18, wherein the beam direction is a first beam direction, wherein the incoming electromagnetic signal is a first incoming electromagnetic signal, wherein the reflected beam is a first reflected beam, and wherein the operations further comprise determining a second beam direction of a second beam to be reflected by the reconfigurable intelligent surface, and reflecting a second incoming electromagnetic signal from the reconfigurable intelligent surface as a second reflected beam based on the second beam direction and the second group of activated subarrays.

20. The non-transitory machine-readable medium of claim 18, wherein the determining that the first aperture coverage pattern comprises a potentially failing subarray is performed by a trained model.
